(19) United States
(12) Patent Application Publication
(10) Pub. No.: US 2026/0140878 A1
(43) Pub. Date: May 21, 2026

(54) ARTIFICIAL INTELLIGENCE ACCELERATOR HAVING COMPUTING UNITS HETEROGENEOUSLY INTEGRATED WITH MEMORY DIES

(71) Applicant: ADEIA SEMICONDUCTOR TECHNOLOGIES LLC, San Jose, CA (US)

(72) Inventors: Xu Chang, San Jose, CA (US); Alan Massengale, Fremont, CA (US); Seung Kang, San Diego, CA (US)

(21) Appl. No.: 18/999,161

(22) Filed: Dec. 23, 2024

Related U.S. Application Data
(60) Provisional application No. 63/721,285, filed on Nov. 15, 2024.

(51) Int. Cl. G06F 12/0802

(52) U.S. Cl. CPC G06F 12/0802; G06F 2212/60

(57) ABSTRACT

Disclosed are architectures of semiconductor integrated circuit (IC) device, more specifically an artificial intelligence (AI) accelerator. The AI accelerator comprises a processing block, a memory block disposed laterally side-by-side to each other and over a common substrate, and a logic base die vertically interposed between the common substrate and the memory block. The processing block comprises a computing die that comprises a plurality of parallel processing cores for processing artificial intelligence algorithms. The memory block heterogeneously integrated with the processing block through electrical connections formed in the common substrate. The memory block comprises a memory stack that comprises one or more vertically stacked memory die layers. The logic base die comprises one or more data communication interfaces between the memory block and the processing block. The data communication interfaces include at least a network on chip configured to electrically connect the memory block with each processing core.

This application claims the benefit of U.S. Provisional Patent Application No. 63/721,285, titled “ARTIFICIAL INTELLIGENCE ACCELERATOR HAVING COMPUTING UNITS HETEROGENEOUSLY INTEGRATED WITH MEMORY DIES” and filed on Nov. 15, 2024, the disclosure entire contents of which is hereby incorporated by reference in its entirety-and for all purposes.

### TECHNICAL FIELD

This disclosure generally relates to semiconductor integrated circuit (IC) architectures and, more particularly, to artificial intelligent (AI) accelerators, having one or more processing blocks, one or more stacked memory blocks, and a separately fabricated base die that is heterogeneously integrated with the processing blocks on a common substrate, where the base die is vertically disposed between the memory blocks and common substrate. Additionally, this disclosure provides various AI accelerator architectures with an emphasis on memory-centric designs. In such designs, one or more memory blocks are positioned centrally, while the processing blocks are arranged along the edges. Furthermore, the disclosure presents various three-dimensional AI architectures, where multiple processing blocks are integrated on one side of a common substrate, and one or more memory blocks are integrated on the opposite side.

### BACKGROUND

Semiconductor integrated circuit (IC) devices have numerous applications, including consumer electronics, industrial applications, communication applications, and cloud system applications, to name a few. The AI accelerator architectures include various types of semiconductor devices and are designed to perform data processing and computation in accordance with commands or instructions for each specific application. The semiconductor devices generally include various types of processing units, which are generally adapted for executing one or few instructions at a time, and memory, which is generally adapted for storing data. For example, an AI accelerator is a type of semiconductor device designed to improve the performance and efficiency of processing artificial intelligence (AI) workloads, such as processing AI algorithms related to tasks involving machine learning (ML), deep learning, neural networking, and the like. Such an AI accelerator is designed to handle the intensive computational demands of the AI algorithms and generally includes additional semiconductor components, logic circuitry, processors, and peripheral circuitry to process data based on specific applications. However, in spite of the technological development in the field of AI accelerator architecture, a continuing demand for increasing computational resources of the AI accelerator poses technical limitations. For example, continuing technological trends of the AI accelerator demand increasing miniaturization (e.g., smaller form factor with increasing performance), increasing energy efficiency (e.g., consuming less power and managing heat more efficiently), and innovative integration approaches (e.g., combining multiple functions into a single chip to reduce size and cost) of the AI accelerator. Accordingly, there is a need for improved AI accelerator architecture, especially for the AI accelerator. Therefore, improved AI accelerators are needed to meet these demands.

### SUMMARY

In one aspect, an artificial intelligence (AI) accelerator comprises a processing block, a memory block disposed laterally side-by-side to each other and over a common substrate, and a logic base die vertically interposed between the common substrate and the memory block. The processing block comprises a computing die that comprises a plurality of parallel processing cores for processing artificial intelligence algorithms. The memory block is heterogeneously integrated with the processing block through electrical connections formed in the common substrate. The memory block comprises a memory stack that comprises one or more vertically stacked memory die layers. The logic base die comprises a logic base die processing core and one or more data communication interfaces between the memory block and the processing block. The data communication interfaces include a network on chip (NoC) configured to communicatively couple the memory block with each of the parallel processing cores. In some embodiments, the common substrate comprises a semiconductor interposer which in turn comprises electrical connections therein. In some examples, the processing cores fabricated at a more advanced technology node relative to the logic base die. For example, the transistors in the processing cores may be fabricated at a more advanced technology node than the technology node of the logic base die.

In another aspect, a first processing block, a second processing block, a first memory block, and a second memory block disposed laterally side-by-side to each other and over a common substrate. The first and second memory blocks are disposed on a central portion of the common substrate, where the first processing block is laterally disposed on a first side of the central portion, and the second processing block is laterally disposed on a second side of the central portion opposite to the first side. Each processing block of the first and second processing blocks includes a computing die. The computing die includes a plurality of parallel processing cores for processing artificial intelligence algorithms. Each memory block of the first and second memory blocks is heterogeneously integrated with the first and second processing blocks through electrical connections formed in the common substrate Each memory block includes a memory stack, having one or more vertically stacked memory die layers. The AI accelerator also includes a logic base die vertically interposed between the common substrate and the first and second memory blocks, where the first and second memory blocks are stacked on the logic base die. The logic base die includes one or more data communication interfaces between the first and second memory blocks and the first and second processing blocks. The data communication interfaces include a NoC configured to electrically connect each memory block with each of the parallel processing cores.

In another aspect, an AI accelerator comprises a processing block and a memory block disposed laterally side-by-side to each other and over a common substrate. The processing block comprises a computing die that comprises a plurality of parallel processing cores for processing artificial intelligence algorithms. The memory block is heterogeneously integrated with the processing block through electrical connections formed in the common substrate, and the memory block comprises a memory stack and a memory base die. The memory stack comprises one or more vertically stacked memory die layers. The memory base die is vertically interconnected with each of the one or more vertically stacked memory die layers and positioned vertically between the memory stack and the common substrate. The memory base die comprises a memory peripheral circuitry configured for controlling operations of the one or more of the vertically stacked memory die layers and a network on chip (NoC) configured to communicatively couple the memory stack with each of the parallel processing cores.

In another aspect, an AI accelerator comprises a plurality of processing blocks and one or more memory blocks disposed laterally side-by-side to each other and over a common substrate. At least one of the processing blocks are arranged adjacent to a first edge or side surface of the common substrate, and at least another one of the of processing blocks are arranged adjacent a second edge or side surface of the common substrate. The first and second edges or side surfaces may or may not be directly connected. Each of the processing blocks comprises a computing die that comprises a plurality of parallel processing cores for processing artificial intelligence algorithms. The memory blocks are disposed at a central region, where the central region laterally separate at least one of the processing blocks and the at least another one of the of processing blocks. Each of the at least one of the memory blocks comprises a memory stack that comprises one or more vertically stacked memory die layers. The common substrate comprises electrical connections therein for communicatively coupling the one or more memory blocks with the processing blocks.

In another aspect, an AI accelerator comprises a processing block and a memory block disposed laterally side-by-side to each other and over a common substrate. The memory block is heterogeneously integrated with the processing block through electrical connections formed in the common substrate. The memory block comprises a memory stack that comprises one or more vertically stacked memory die layers. The processing block comprises a computing die that comprises a plurality of parallel processing cores for processing artificial intelligence algorithms. The computing die is disposed backside up on the common substrate with a computing die substrate facing away from the common substrate, and the computing die substrate has formed through backside power delivery network interconnects electrically connected to a transistor layer of the computing die for receiving power from a backside of the computing die.

In another aspect, an AI accelerator comprises a processing block and a memory block bonded to opposing sides to a common substrate. The processing block comprises a computing die that comprises a plurality of parallel processing cores for processing artificial intelligence algorithms. The memory block is heterogeneously integrated with the processing block through electrical connections formed in the common substrate. The memory block comprises a memory stack that comprises one or more vertically stacked memory die layers. The common substrate comprises a logic base die vertically interposed between the processing block and the memory block. The logic base die comprises a processing core and one or more communication interfaces between the memory block and the processing block. The data communication interfaces include a network on chip (NoC) configured to communicatively couple the memory block with each of the parallel processing cores.

In another aspect, an AI accelerator comprises a plurality of processing blocks bonded to a common substrate on the first side and a plurality of memory blocks bonded to the common substrate on the second side, opposing the first side. Each of the processing blocks comprises a computing die that comprises a plurality of parallel processing cores for processing artificial intelligence algorithms. Each of the memory blocks comprises a memory stack that comprises one or more vertically stacked memory die layers. At least some of the processing blocks vertically overlap with corresponding ones of the memory blocks, and overlapping ones of processing blocks and memory blocks are configured to electrically communicate in a vertical direction through the communication interfaces formed in corresponding overlapping regions. The data communication interfaces include a network on chip (NoC) configured to communicatively couple the memory block with each of the parallel processing cores.

In another aspect, an AI accelerator comprises a plurality of processing blocks bonded to a common substrate on the first side and a plurality of memory blocks bonded to the common substrate on the second side, opposing the first side. Each of the processing blocks comprises a computing die that comprises a plurality of parallel processing cores for processing artificial intelligence algorithms. The computing die is disposed backside up on the common substrate with a computing die substrate facing away from the common substrate, and the computing die substrate has been formed through backside power delivery network interconnects electrically connected to a transistor layer of the computing die for receiving power from a backside of the computing die. Each of the memory blocks comprises a memory stack that comprises one or more vertically stacked memory die layers. The common substrate comprises a logic base die vertically interposed between the processing blocks and the memory blocks. The logic base die comprises a processing core and one or more communication interfaces between the memory blocks and the processing blocks. At least some of the processing blocks vertically overlap with corresponding ones of the memory blocks, and overlapping ones of processing blocks and memory blocks are configured to electrically communicate in a vertical direction through the communication interfaces formed in corresponding vertically overlapping regions. The data communication interfaces include a network on chip (NoC) configured to communicatively couple the memory block with each of the parallel processing cores.

In yet another aspect, an AI accelerator comprises a plurality of processing blocks bonded to a common substrate at a first side thereof and a plurality of memory blocks bonded to the common substrate at a second side opposing the first side. Each of the processing blocks comprises a computing die that comprises a plurality of parallel processing cores for processing artificial intelligence algorithms, and the computing die is disposed backside up on the common substrate with a computing die substrate facing away from the common substrate. The computing die substrate has formed therethrough backside power delivery network interconnects electrically connected to a transistor layer of the computing die for receiving power from a backside of the computing die. Each of the memory blocks comprises a memory stack comprises one or more vertically stacked memory die layers. The common substrate comprises a logic base die vertically interposed between the processing blocks and the memory blocks. The logic base die comprises a processing core and one or more communication interfaces between the memory blocks and the processing blocks. Adjacent ones of the memory blocks are separated by a gap such that spaces between the memory blocks form network of channels. The channels are sealed and configured to flow a liquid coolant therethrough. The data communication interfaces include a network on chip (NoC) configured to communicatively couple the memory block with each of the parallel processing cores

### BRIEF DESCRIPTION OF THE DRAWINGS

The following detailed description of illustrative embodiments is better understood when read in conjunction with the appended drawings. For the purpose of illustrating the present disclosure, exemplary constructions of the disclosure are shown in the drawings. Moreover, those skilled in the art will understand that the drawings are not to scale. Wherever possible, like elements have been indicated by identical numbers. The detailed description of embodiments and the embodiments set forth in the drawings present various descriptions of specific embodiments of the invention. However, the invention can be embodied in a multitude of different ways. It will be understood that certain embodiments can include more elements than illustrated in a drawing and/or a subset of the elements illustrated in a drawing. Further, some embodiments can incorporate any suitable combination of features from two or more drawings. The present disclosure is not limited to specific methods and apparatus disclosed herein.

FIG. 1A is a side view illustrating an example arrangement of an artificial intelligence (AI) accelerator having a memory block and a processing block, according to an embodiment.

FIG. 1B is a side view illustrating an example arrangement of an AI accelerator having multiple memory blocks and processing blocks, according to an embodiment.

FIG. 2A is a side view illustrating an example arrangement of an AI accelerator having a memory block and a processing block, according to an embodiment.

FIG. 2B is a side view illustrating an example arrangement of an AI accelerator having multiple memory blocks and processing blocks, according to an embodiment.

FIG. 3 illustrates an example block diagram of a processing block, according to an embodiment.

FIG. 4 illustrates an example processing block having back side power delivery network, according to an embodiment.

FIGS. 5A-5D illustrate various examples of memory-centric AI accelerator architectures, according to some embodiments.

FIG. 6 illustrates a top-down view of an example of a memory block configuration having multiple stacked memories vertically arranged on a logic base die, according to an embodiment.

FIGS. 7A-7B illustrate various examples of AI accelerator, implementing a redistributed layer (RDL) on the memory block, according to some embodiments.

FIG. 8 illustrates an example of a three-dimensional view of representing a memory block configuration, according to an embodiment.

FIGS. 9A-9C illustrate examples of side views of three-dimensional AI accelerators, according to some embodiments.

FIGS. 10A-10C illustrate various additional examples of three-dimensional AI accelerators, according to some embodiments.

FIGS. 11A-11M illustrate an example of a process flow of a method of manufacturing an AI accelerator, according to an embodiment.

FIG. 12 illustrates an example of an array of memory blocks with micro fluid channels, according to an embodiment.

FIGS. 13A and 13B illustrate examples of detailed 3D stacking (e.g., 3D bonding) bonding structures.

FIGS. 14A-14D illustrate various example arrangements of additional memory-centric AI accelerator architectures, according to some embodiments.

### DETAILED DESCRIPTION

Although several embodiments, examples, and illustrations are disclosed below, it will be understood by those of ordinary skill in the art that the disclosure described herein extends beyond the specifically disclosed embodiments, examples, and illustrations and includes other uses of the disclosure and obvious modifications and equivalents thereof. Embodiments are described with reference to the accompanying figures, wherein like numerals refer to like elements throughout. The terminology used in the description presented herein is not intended to be interpreted in any limited or restrictive manner simply because it is being used in conjunction with a detailed description of some specific embodiments of the disclosure. In addition, embodiments can comprise several novel features. No single feature is solely responsible for its desirable attributes or is essential to practicing the disclosure herein described.

The semiconductor industry is experiencing a surge in demand for enhanced computational resources, driven by the need for greater performance to manage increasingly complex workloads and the rapid expansion of data. This trend is particularly pronounced in areas such as artificial intelligence (AI), machine learning (ML), high-performance computing (HPC), and cloud systems, all of which may need substantial processing capabilities to handle vast amounts of data, across various applications. To address these and other needs, the industry has concentrated on developing semiconductor devices with higher transistor densities to boost computational performance while optimizing power consumption. One strategy to meet the growing performance demands has been the development of AI accelerators. AI accelerators includes specialized hardware components designed to enhance the performance of AI workloads, such as the performance of executing AI algorithms. Some AI accelerators implement parallel processing units capable of simultaneously handling large volumes of data by performing multiple computations in parallel. Additionally, AI accelerators utilize stacked memory configurations, such as high-bandwidth memory (HBM) with stacked dynamic random access memory (DRAM), to enable high-speed data transfer, providing the memory resources to support the increasing demands of AI processing. However, some AI accelerators face several technical challenges. One limitation is their restricted hardware scalability, which hampers the ability to incorporate additional processing units. For example, in some traditional designs, multiple computing units and interface circuitry, including, e.g., circuitry that manage data communication between computing units and memory blocks. are fabricated on the same die. This approach, monolithic integration, uses on-chip integration of features such as transistors at the same technology node for both the interface circuitry and the computing units. As disclosed herein, a technology node, often identified based on a set of feature sizes, is associated with a set of minimum physical feature sizes, e.g., gate length of a transistor. While monolithic integration can provide some advantages by enabling the fabrication of different devices on a common substrate, this integration can also introduce unnecessary cost and/or performance tradeoffs. For example, as technology nodes become more advanced, the associated fabrication costs can increase significantly. However, certain technologies are more challenging to scale or may not need aggressive scaling, where other technologies may be more scalable and need aggressive scaling than the certain technologies. For example, mixed signal and analog circuitry (e.g., circuitry in PHY layers) may not scale well, and benefits of scaling may be limited, relative to digital circuitry for computation. As such, on the one hand, monolithic integration of various features at an advanced node can lead to unnecessarily (e.g., disproportionately) high fabrication costs for features that may not substantially benefit from such advanced scaling, while on the other hand, monolithic integration of the different features at less advanced node can lead to unnecessary compromise of density or performance of features that do need the advanced scaling. In this regard, the present disclosure provides decoupling the technology nodes between different features, for example, fabricating some features of a processing block (e.g., processing cores) at a more advanced technology node relative to other features, such as features of a memory block (e.g., a logic base die), can provide lower fabrication cost and flexibility throughout heterogenous integration without unnecessarily compromising performance. For example, in some monolithic integration approaches, computing units can be fabricated at a more advanced technology node compared to interface circuitry due to the relative difficulty of the scalability of the interface circuitry relative to the processing cores. For instance, the computing unit (e.g., including one or more processing cores) may utilize a more advanced technology node than the interface circuitry. For example, the processing core may be fabricated using a 20 nm technology node, while the interface circuitry is fabricated using a 40 nm technology node. However, when monolithically integrating these components onto a single die, manufacturing constraints or design compatibility may need fabricating these components at the larger technology node (e.g., 40 nm). Consequently, the computing unit cannot fully leverage the performance and area advantages of the smaller 20 nm node, potentially reducing the number of processing cores that can be included compared to fabrication at the 20 nm technology node. Such scaling constraints can limit the computing unit's performance. For the purposes of this description, a technology node that can be scaled to a smaller dimension is referred to as an advanced technology node. However, the present disclosure does not define or limit the specific range of the advanced technology node. For example, if the computing unit has a 20 nm technology node and the interface circuitry has a 30 nm technology node, the technology node of the computing unit can be considered an advanced technology node. It will be appreciated that the technology nodes for particular process architecture may advance over time, e.g., according to what is known as Moore's Law, and are merely provided as examples for the purpose of description. The present disclosure does not limit the size of the technology node, and commercially available technology node can be used without limitation.

As disclosed herein, features fabricated at different technology nodes, e.g., features of a processing block (e.g., processing cores) fabricated at a more advanced technology node relative to features of a memory block (e.g., a logic base die), may be fabricated at technology nodes that are separated by one, two, three, four, five or more technology nodes. Further, successive nodes represent an area shrinkage of at least some corresponding areas of the semiconductor dies having the different features by more than 30%, 40%, 50%, 60%, 70%, or value in a range defined by any of these values. Alternatively, successive nodes represent a shrinkage of a lateral dimension of at least some corresponding features, e.g., transistor electrical gate length or lowest metal pitch, by more than 20%, 30%, 40%, 50%, or value in a range defined by any of these values. In some examples, the shrinkage of the node dimension can be achieved by using advanced transistor architecture across the nodes. For example, the technology node can include Fin Field-Effect Transistor (FinFET), which is more advanced than planar transistors (e.g., planar Metal-Oxide-Semiconductor Field-Effect Transistor (MOSFET)). In some examples, the technology node can include Gate-All-Around (GAA) or Nanosheet transistors, which are more advanced than the FinFET and MOSFET. These types of transistors are provided as examples for the purpose of describing the technology node, and the present disclosure does not limit the types of transistors used in the technology node.

Another limitation faced by traditional AI accelerators is performance degradation due to heat generated by the processing unit. In some architectures, the processing unit, including multiple computing units and interface circuitry, can generate heat, which may not be efficiently dissipated. For example, the processing unit may be located at the center of the AI accelerator, with memory blocks positioned around it. Such configuration can cause the interface circuitry at the center to manage data communication between the computing units and the surrounding memory blocks. In this design, heat generated by the processing units tends to accumulate at the center, raising the operating temperature of the AI accelerator and limiting its performance due to thermal constraints.

### Overview of AI Accelerator

Semiconductor integrated circuit (IC) devices include various IC device components, including various types of processors and memories. The memories can include random-access memories (RAM), e.g., dynamic RAM (DRAM) or static RAM (SRAM), and/or storage or nonvolatile memories such as flash memory. The processors can include general-purpose central processing units (CPUs), which are generally adapted for executing one or few instructions at a time, and tensor processing units (TPUs), which may be specially adapted for handling the demanding computations for training neural networks, such as deep learning tasks, and graphics processing units (GPUs), which contain hundreds or thousands of co-processors that compute instructions in parallel. The IC device components also include various logic circuitry to perform logical operations. Generally, the semiconductor compute IC device components are integrated on a chip, or a semiconductor die, such as integrated as a system-on-chip.

Various types of AI accelerators can be designed by implementing specific hardware components based on the purpose of IC device. For example, an AI accelerator can be designed to improve the performance and efficiency of artificial intelligence (AI) workloads. Such AI workloads generally refer to the computational tasks and processes involved in running AI algorithms, including machine learning (ML) and deep learning (DL) algorithms. These workloads typically include data processing, AI model training, inference, and sometimes real-time decision-making, all of which may need significant computational resources. The AI accelerator is specifically designed to meet such needs by implementing a processing unit and memory unit.

The processing unit of the AI accelerator comprises multiple sub-blocks, referred to as functional blocks. Each functional block contains one or more semiconductor components that perform specific tasks within the processing unit. These functional blocks may include but are not limited to, a computing block, one or more memory blocks, and one or more interface blocks. The computing block includes processing cores designed to process AI workloads. These processing cores can include various types, such as tensor processing cores that accelerate tensor computations like matrix multiplications in neural networks; vector processing cores that perform parallel vector operations efficiently; arithmetic logic cores that execute fundamental mathematical operations; floating-point cores that handle complex floating-point arithmetic operations; and graphics processing cores that perform AI algorithm tasks in parallel. The memory block of the processing unit can include multiple levels of cache memories implemented as SRAM or other types of RAM, providing fast access to frequently used data. The interface blocks consist of an interface block and an interface logic block. The interface block contains interface circuitry that interconnects the processing cores of the processing unit with the memories in the memory unit. The interface logic block includes interface logic circuitry that facilitates communication between the processing cores and the memory unit. The interface logic block can also include a memory controller configured to control read or write operations of the memory data stored in the memory blocks. For example, the interface logic circuitry may comprise various configurations of transistors arranged to perform data routing based on logic circuitry. For the purpose of description, the computing blocks can also be referred to as processing blocks, where the processing blocks can also be referred to as processing cores.

While specific semiconductor components or integrated circuits (ICs) are described in connection with the embodiments disclosed herein, this disclosure does not limit the number or types of semiconductor components used. The number and type of components can vary based on specific applications and design requirements.

In some AI accelerator designs, the processing unit and the memory block are integrated on a substrate. The processing unit includes the computing block, one or more memory blocks (e.g., cache memories), and one or more interface blocks are integrated on the same substrate. The memory block includes stacked memory dies and a memory base die, such that the stacked memory dies are communicatively coupled with the memory base die, where the memory base die provides interconnection circuitry to the interface block of the processing unit via physical layer interconnection. Thus, the processing unit and the memory block are communicatively coupled via the interface block of the processing unit, and the interconnection circuitry of the memory base die.

Some AI accelerators can face technical limitations in effectively integrating components and optimizing performance. One significant limitation is the scalability of the processing unit when the computing block, memory blocks, and interface blocks are implemented on the same die. In these designs, the processing cores (included in the computing block), cache memories (included in the memory block), and the interface logic circuitry (as well as the memory block of the processing unit) are monolithically integrated on the same substrate, at the same technology node, and sharing a common design rule. This common technology node can be determined based on the scalability of the technology nodes for the processing cores, cache memories, and interface logic circuitry. For example, if the processing cores can be scaled down to a 10 nm technology node, cache memories to a 20 nm node, and the interface logic circuitry to a 30 nm node, then monolithically integrating these components onto the same substrate may constrain the entire semiconductor device to be fabricated at a node that is too advanced and unnecessarily costly, or at node that is too less advanced and performance-compromising. This constraint arises because the integration process may need to accommodate the least scalable component-in this case, the interface logic circuitry at 30 nm. Consequently, the device may not fully exploit the performance and area advantages of the smaller technology nodes available to other components. In some examples, each level of cache memory may have different scalability regarding the technology node, adding further complexity to the integration process. This limitation can cause design constraints in the semiconductor device, such that it can be disadvantageous for AI accelerator design because it restricts the number of processing cores that can be integrated into the computing unit. Increasing the number of processing cores is desirable to meet the demands of AI task processing by enhancing performance.

In addition, some AI accelerators have design limitations due to the placement of the processing unit at the center of the device, with memory units positioned around it. For example, the processing unit may be centrally located within the accelerator, with a memory unit closer to the edges. This arrangement is advantageous because the interface block, which includes the interface circuitry, is fabricated on the processing unit itself. Each computing core within the processing unit needs to be connected to the memory units, and this connection is established via the interface block. Thus, the processing cores are connected to the memory units located around the processing unit through the interface block of the processing unit. This design can lead to the processing unit being flanked by memory units on both sides.

Some AI accelerator's performance can be further improved with respect to heat accumulation adjacent to the accelerator. During operation, the processing unit generates substantial heat, which tends to concentrate in the central region of the accelerator where the processing unit is located. This accumulation of heat can significantly raise the temperature in the core of the device. To maintain the AI accelerator within its optimal operating temperature range, thermal management strategies may be implemented, such as reducing the clock speed or enhancing cooling mechanisms. However, these measures can lead to performance degradation because they limit the processing unit's ability to operate at higher capacity to prevent overheating.

To address these and other needs of the AI accelerator, aspects of the present disclosure provide various embodiments of novel AI accelerators and methods of manufacturing the AI accelerator.

In various embodiments, the disclosed AI accelerators are designed to optimize performance by heterogeneously integrating one or more semiconductor components of the processing blocks based on their respective optimal technology node as discussed above. In some embodiments, multiple processing cores within a processing block, along with specific lower levels of cache memory (e.g., L1 and/or L2 levels of cache memory) that are fabricated at a common advanced technology node (e.g., the technology node at which the processing cores are fabricated), are integrated on a single substrate. Other semiconductor components, such as interface components (e.g., interface circuitry), peripheral components (e.g., memory controller), and/or higher levels of cache memory (e.g., L3 or last-level cache), which may be less scalable and can be fabricated at a less advanced technology node than the processing cores, are fabricated separately at different technology nodes on a different substrate. This approach allows the processing cores and lower-level cache memory to leverage advanced, more advanced technology nodes while accommodating components with less scalability on a separate substrate. For the purpose of description, the die including the processing cores can be referred to herein as the computing die. According to embodiments, the transistors within the processing cores, as well as the first level of cache memory, are integrated on a single die, and the other transistors forming the interface circuitry, the peripheral circuitry, and the higher level cache memories are separately fabricated on a die different from the computing die. In some examples, the processing block can include one or more computing dies, and each computing die includes a plurality of parallel processing cores. Also, in some examples, the processing block can also include one or more lower level cache memories, such as L1 and L2cache memory.

In some examples, a logic base die is heterogeneously integrated with the processing block. The logic base die may include the interface circuitry, various logic circuits, cache memory, peripheral circuitry, and other elements. In some embodiments, the transistors in these circuitries can be fabricated using a different technology node than the transistors in the processing blocks. For example, the processing blocks may utilize a more advanced, smaller technology node with higher scalability, while the logic base die may employ a less advanced, larger technology node with lower scalability. In certain embodiments, the interface circuitry of the logic base die includes a network on chip (NoC) and other interfaces, while the peripheral circuitry may handle tasks such as cache coherence, memory access, memory built-in self-test (MBIST), and other functionalities. Additionally, the cache memory may include various SRAM or other types of RAM used for different levels of cache memory.

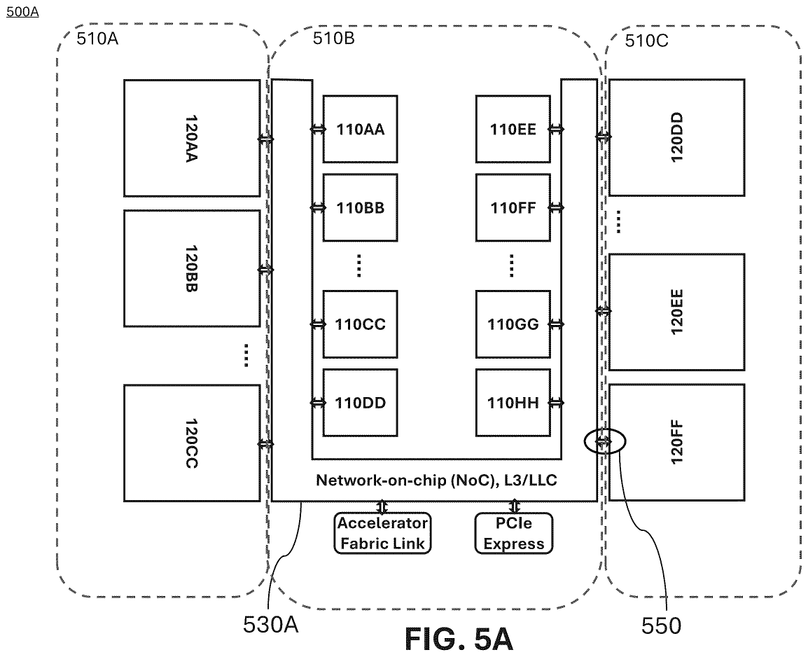

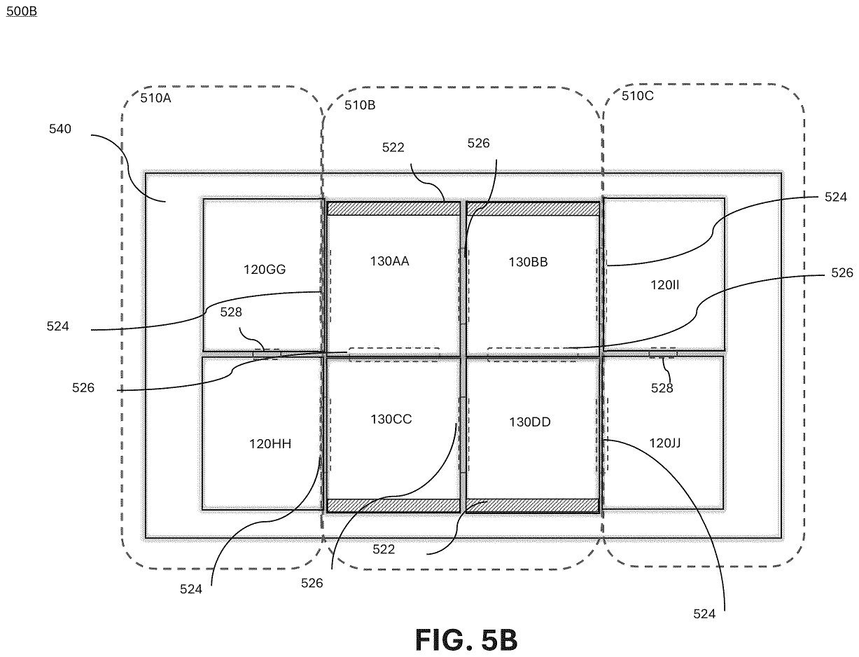

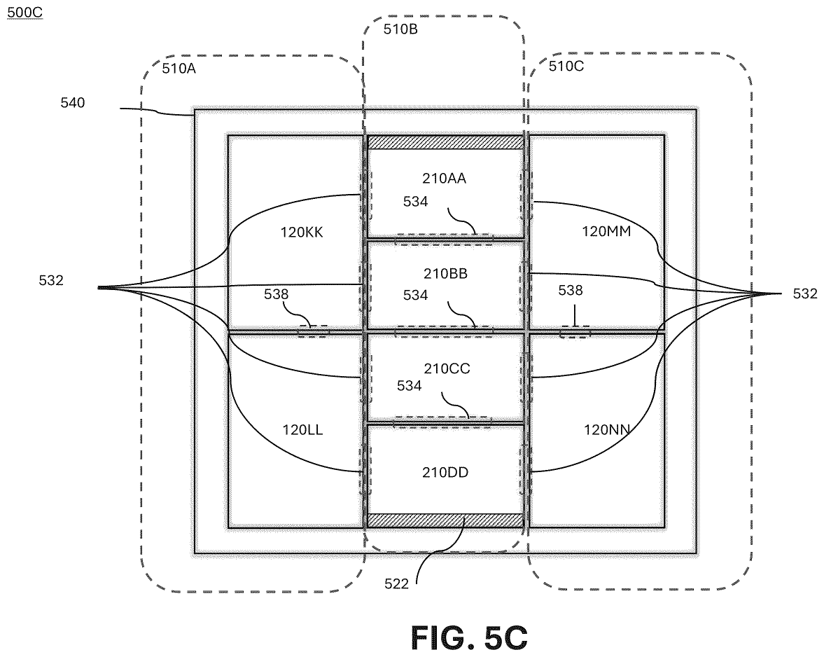

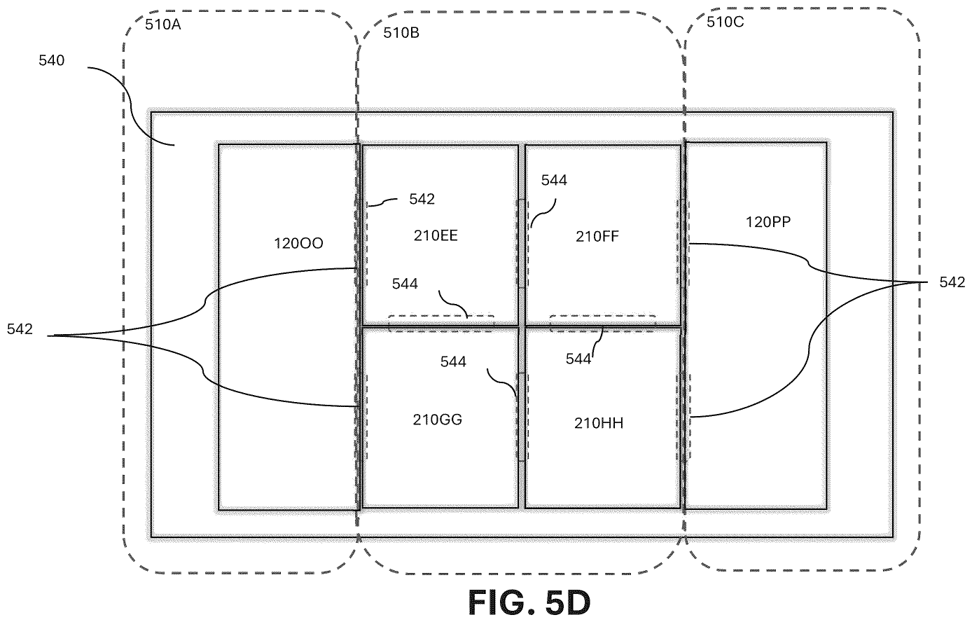

For the purpose of description, parallel computing can refer to splitting a large computational task into small tasks, which are then processed simultaneously across multiple processing units. Parallel computing can be a particularly useful computation method utilized in AI computing because AI tasks, such as matrix multiplication in neural networks, can be broken down and computed concurrently (e.g., simultaneously). The NoC of the AI accelerator can enable the parallel computing. For example, each processing core has access to each memory block. When processing or computing a relatively computation-heavy workload, data in one or small number of memory blocks may be accessed by a plurality of processing cores (e.g., simultaneously). For instance, when processing a memory intensive workload, one or small number of processing cores may access (e.g., simultaneously) data in a plurality of memory blocks. The NoC, as described herein, generally refers to switch-based network components for connecting heterogeneously integrated blocks, e.g., a memory block and a processing block. In some embodiments, the NoC may be monolithically integrated with other circuitry, e.g., as part of a logic base die of the AI accelerator. In other embodiments. the NoC functionalities may be distributed in multiple logic base dies of the AI accelerator (for example, as illustrated in FIGS. 5B-5D) and the multiple logic base dies are connected to each other with USR or UCIe die-to-die interface. In some implementations, various circuit components that provide the NoC functionalities may be distributed across multiple logic base dies. In these arrangements, the distributed circuit components may collectively be referred to as the NOC of the AI accelerator. The switch-based components can include, e.g., communication links, routers, and network interfaces. A communication links can include a set of wires connecting two or more routers. A router can include input port and output ports, and a switching matrix. Network interfaces serve as interfaces between the heterogeneously integrated blocks and the network components. For example, an NoC can include interconnect architecture within the AI accelerator designed to transfer data between the processing block (e.g., containing processing cores), cache memories, memory blocks (e.g., stacked DRAM), peripheral circuitry (e.g., the memory controller), and other interface circuitries (e.g., Ultra Short Reach (USR), Universal Chiplet Interconnect Express (UCIe), accelerator fabric links, PCIe interfaces) within the AI accelerator. The NoC may also enable simultaneous data communication between processing cores and memory blocks by routing data in parallel across multiple data paths within the AI accelerator. Furthermore, the NoC can be implemented using various architectures, including mesh, torus, and other topology-based structures, without limitation to a particular topology. Accelerator fabric links refer to data communication standards used to transfer data between AI accelerators or between an AI accelerator and a central processing unit (CPU) connected to the accelerator. The USR/UCIe provide standardized protocols for data communication between chiplets. In some cases, the processing block and memory block are connected via USR/UCIe die-to-die interface, such as between the logic base die and the computing die.

The cache coherence circuitry is configured to ensure that changes made to one cache memory are accurately reflected in other caches. The memory access circuitry or memory controller, manages the flow of data between the memory block and the processing block by handling read and write operations. For example, the memory controller is configured to manage the flow of data to and from the memory block. For example, the memory controller functions as an intermediary between the processing block and the memory block to ensure the correct data is read and/or written to/from the memories (e.g., stacked DRAM) of the memory block by performing, for example, address translation, data transfer, memory initialization, error detection and correction, and the like.

The MBIST circuitry is responsible for performing self-tests on the memory block, using customizable techniques to verify and test the memory's functionality. MBIST detects manufacturing defects and ensures the reliability of the memory.

In some cases, the logic base die may include a logic base die processing core that controls and manages the interface logic for the NoC, various other interfaces, and the operation of peripheral circuitry, including cache coherence, memory access, MBIST, and other related functions.

In various embodiments, the disclosed AI accelerator is designed to optimize performance by fabricating different components separately, based on the ease of scaling of each semiconductor component. For example, a processing block, which includes a plurality of processing cores fabricated on a single substrate (e.g., computing die). These processing cores can be scaled according to the technology node suitable for the processing cores, resulting in an optimized integration of the overall technology node. This computing die can be configured to process various AI algorithms efficiently. For example, the computing die, having a higher density of the processing cores, can have higher performance (e.g., in parallelly processing the AI algorithms or tasks) than the other computing die, having a lower number of processing units. In some embodiments, to optimize the performance of the computing die, semiconductor components fabricated at the advanced technology node-may be fabricated on the same substrate, forming an integrated computing die. In these embodiments, a logic base die is heterogeneously integrated with the computing die through three-dimensional (3D) die-to-die bonding or 2.5D die-to-die connection. The logic base die can include various circuitry, having a different scalability of technology node from the components included in the computing die, such that the overall technology node of the computing die can be lower than the technology node of the components included in the logic base die. For example, the logic base die can include the NoC and other interfaces, as well as the peripheral circuitry, to handle tasks such as signal routing, cache coherence, memory access, MBIST, and other functionalities. Additionally, the logic base die can also include L3 or last level cache (LLC) memory, having SRAMs. For example, the SRAMs included in the LLC memory can have a relatively larger technology node than the other levels of cache memory included in the processing block (e.g., advanced technology node). Thus, the number of processing cores included in the computing die can be increased without having technology node scaling limitation traditionally caused by the interface circuitry in the traditional processing unit of the AI accelerator.

In some instances of the disclosed AI accelerators, the computing die is heterogeneously connected to the NoC of the logic base die via electrical interconnections embedded on a common substrate, such as a silicon interposer, a re-distribution layer (RDL) substrate, or a silicon bridge die. Additionally, a memory block with a vertically stacked DRAM memory die can be directly bonded to the logic base die, positioning the logic base die between the memory block and a common substrate. In some cases, multiple memory blocks can be vertically stacked on top of the logic base die.

In some configurations, the processing block is connected to the multiple memory blocks via the logic base die. For example, two or more memory blocks may be vertically stacked on the logic base die, with each memory block bonded directly to it. In this arrangement, the NoC of the logic base die provides the interface connectivity between each memory block and the processing cores of the computing die, ensuring that each processing core is communicatively coupled to each memory block for efficient data transfer and processing.

In some embodiments, the disclosed AI accelerators employ various memory-centric architectures designed to efficiently dissipate heat generated during AI accelerator operations. In one configuration, two processing blocks and two memory blocks are laterally arranged on a common substrate. For instance, the two memory blocks are positioned at the center of the substrate, while one processing block is placed adjacent to the first edge of the substrate, and the second processing block is placed adjacent to the opposite edge.

Additionally, in this configuration, the logic base die is vertically positioned between the two processing blocks and the common substrate. This design is referred to as a memory-centric AI accelerator architecture. It offers advantages over traditional AI architectures, where processing blocks are typically placed in the center of the substrate and surrounded by memory blocks. The memory-centric design improves heat dissipation by allowing the heat generated by the two processing blocks to be directed outward, reducing the accumulation of heat at the center of the AI accelerator during operation. This enhanced thermal management helps maintain optimal performance by preventing overheating.

In some embodiments, an array of stacked memories is disposed on a center portion of the common substrate, where an array of processing blocks is disposed on a first adjacent to the first edge of the substrate, and an array of second processing blocks is placed adjacent to the opposite edge. A common logic base die can be disposed vertically between the array of stacked memories and the common substrate.

In various embodiments, the computing die, as disclosed herein, can include a backside power delivery network. For example, the computing die includes a front side configured to provide signal routing, a transistor layer (e.g., active layer) having transistors of the plurality of processing cores. The computing die includes a back side configured for backside power delivery network (BSPDN) configured to route power through the backside. The backside can include interconnects through a substrate portion, e.g., through silicon vias (TSVs) formed through a thinned silicon substrate. Illustratively, the BSPDN is formed on the backside of the computing die, and the transistor layer is located between the front-side signal routing network and the BSPDN. The BSPDN mainly delivers power through dedicated metal layers on the back of the computing die, and the power is routed to the transistor layer via through silicon vias (TSVs). The front-side network mainly focuses on signal routing, while the BSPDN efficiently supplies power to the transistor layer by routing it from the backside. This separation of power and signal paths enhances performance by reducing interference and improving power delivery efficiency by reducing the density of interconnects on the front side to reduce, e.g., parasitic coupling between densely populated interconnects. In some cases, the computing die can include only the BSPDN configured to route power.

In some embodiments, the present disclosure provides various three-dimensional AI accelerator architectures. In certain examples, the processing block and memory block are bonded to opposite sides of a common substrate. For instance, the processing block is positioned on a first surface (e.g., top surface) of the common substrate (e.g., a logic base die), while the memory block is placed on the second surface (e.g., bottom surface) of the substrate. As described earlier, the logic base die can include a processing unit and one or more communication interfaces, such as a NoC, that enable data transfer between the memory block and the processing block. For example, the logic base die can incorporate memory peripheral circuitry that controls the operations of the vertically stacked memory block. In some embodiments, the logic base die further includes multiple levels of cache memory, such as a last (highest) level cache (LLC), which can be an L3 cache, which may be composed of SRAM or other types of RAM. This integrated design enhances data access and processing efficiency between the processing and memory blocks.

In some embodiments, the present disclosure further provides various three-dimensional AI accelerator architectures with liquid cooling structures. In some examples, a plurality of processing blocks is integrated on a first surface (e.g., top surface) of the common substrate (e.g., a logic base die and/or a silicon interposer), while a plurality of memory blocks is placed on the second surface (e.g., bottom surface) of the common substrate. In these embodiments, adjacent ones of the memory blocks are separated by a gap such that spaces between the memory blocks form network of channels, where cooling liquid flows to cool the heat generated from the AI accelerator.

To facilitate an understanding of the systems and methods discussed herein, several terms are described below. These terms and other terms used herein should be construed to include the provided descriptions, the ordinary and customary meanings of the terms, and/or any other implied meaning for the respective terms, wherein such construction is consistent with the context of the term. Thus, the descriptions below do not limit the meaning of these terms but only provide example descriptions.

A central processing unit (CPU) can refer to a processing component that performs the processing of data by executing instructions, such as performing basic arithmetic, logic control, and input/output operations in accordance with the instructions. The CPU can have various architectures that dictate how the CPU processes data, executes instructions and communicates with other parts of the computer system. However, the present disclosure does not limit the CPU architectures.

A tensor processing unit (TPU) can generally refer to a processing unit (e.g., a type of application-specific integrated circuit) specifically designed for accelerating machine learning workloads, such as handling computational requirements of machine learning models (for example, a deep learning algorithm). The TPU can include, without limiting, matrix multiplication units configured to perform matrix multiplications in accordance with the machine learning models, memory configured to support data transfer demanded for machine learning workloads, and the like.

A neural processing unit (NPU) can generally refer to a processing unit specifically designed for accelerating machine learning and artificial intelligence computations that involve neural networks. For example, the neural network can generally refer to a network having a plurality of nodes and layers, where each node (organized in specific layer(s)) processes data to perform the task, such as data patter reorganization, data classification, output predictions, and the like. The NPU is designed to perform specific types of mathematical operations used in the neural network. The NPU can include a plurality of processing cores configured to execute multiple operations in the neural network parallelly.

A graphics processing unit (GPU) can refer to a processing unit designed to accelerate graphics rendering. The GPU can include a plurality of cores configured to perform parallel processing. The GPU can have various architectures based on its operation, such as parallel processing. In addition, the GPU can be implemented as a stand-alone processing unit or integrated with other processing units, such as the CPU. The present disclosure does not limit the types of GPU architecture and implementation of the GPU.

A processing in memory (PIM) can refer to a memory architecture, integrating processing unit embedded in the memory.

### AI Accelerator With Enhanced Performance

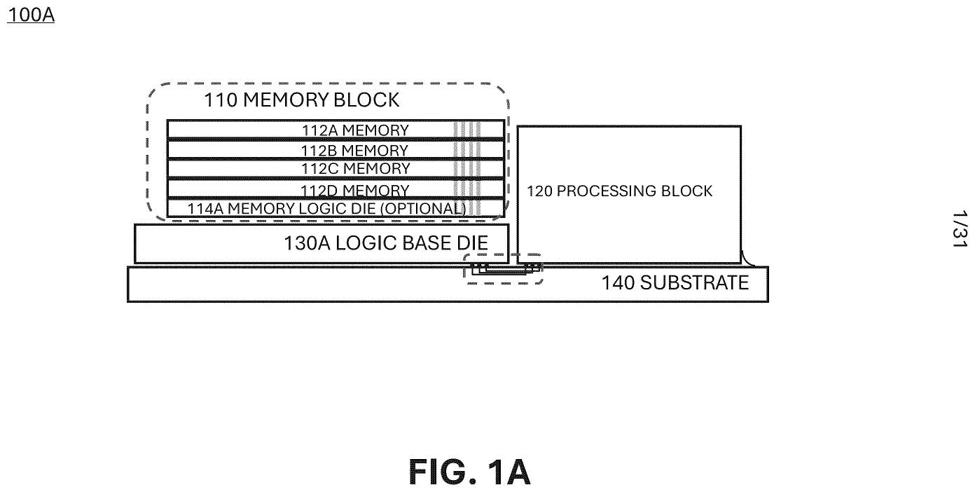

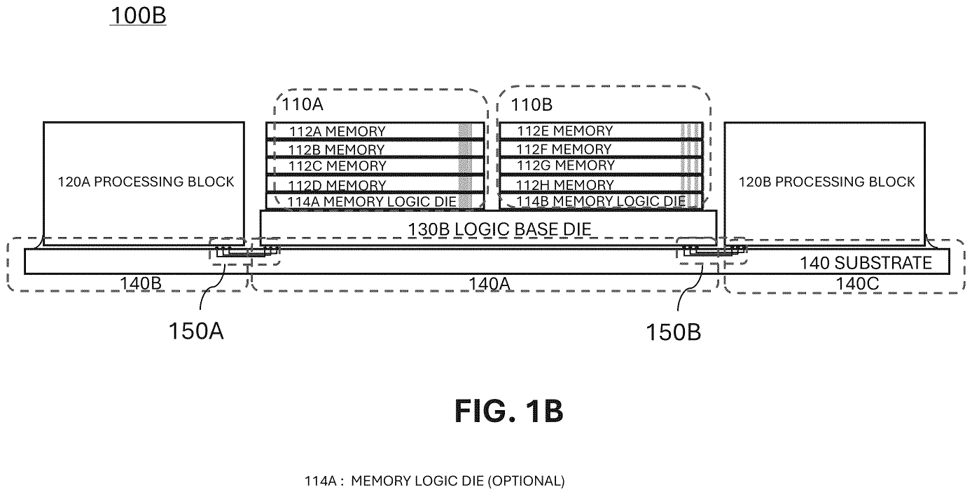

FIG. 1A schematically illustrates a diagram of a novel AI accelerator 100A (hereinafter “AI accelerator 100A”), according to embodiments disclosed herein. As shown in FIG. 1A, the AI accelerator 100A includes a memory block 110, a logic base die 130A, a processing block 120, and a substrate 140.

The memory block 110 comprises a stacked memory (112A-112D), which in this example has four layers. Each layer in the stacked memory can be a DRAM. In some embodiments, at least one of the DRAM layers includes circuitry to process data retrieved from its corresponding DRAM, effectively functioning as processing-in-memory (PIM). For instance, one or more memories in the stacked memory can embed processing units or circuitry to process data stored within them. Alternatively, at least one memory layer could be SRAM. The stacked memory may include a combination of DRAM, SRAM, and PIM layers. Although FIG. 1A illustrates four layers, this is merely an example; the number of stacked memory layers is not limited and can be 6, 8, 10, 12, 14, 16, 18, 20 or even more layers.

The processing block 120 includes a plurality of parallel processing cores designed to process AI workloads in parallel. These cores can be integrated in a computing die and can include GPUs, NPUs, CPUs, or any combination thereof, and the present disclosure does not limit the types and number of processing cores. The processing block 120 may also include multiple levels of cache memory. For example, it can include a first-level (L1) cache that is larger than a register file but disposed in close proximity to and monolithically integrated with the processing cores to store frequently used data and instructions for faster access. Although the L1 cache has slightly higher latency than registers, it significantly reduces the processing unit's dependency on slower external memory. Additionally, one or more higher level cache, e.g., a second-level (L2) cache, may be included, offering greater storage capacity than the L1 cache but with increased latency. It stores data and instructions accessed less frequently but still needs quicker access than the main memory (e.g., memory block). One or more higher levels of cache memories can be monolithically integrated or heterogeneously integrated, e.g., positioned vertically below, e.g., bonded to, the computing die (e.g., heterogeneously integrated with the processing cores, such as integrated in a memory chiplet) and can include SRAM. Other levels of cache memory may also be implemented based on application needs.

In some embodiments, the processing cores can be monolithically fabricated on a single die. The number of processing cores can be optimized based on the scalability of its technology node used in the processing cores. In some embodiments, the processing cores and the cache memories are fabricated in a die (e.g., computing die). In these embodiments, the transistors in the processing cores and those in the cache memories (configuring the SRAMs) can have the same or nearly the same scaling factor.

The processing block 120 may also include interconnection circuitry to interface with the logic base die 130A. This interconnection circuitry supports die-to-die connections using interfaces like USR/UCIe without the need for an intervening die. Utilizing USR/UCIe interfaces over traditional PHY layer interfaces (which involve encoding or decoding using PHY) offers advantages in scalability, latency, bandwidth, data rate, and power efficiency.

FIG. 1A also illustrates the logic base die 130A, which can include interface circuitry, peripheral circuitry, and cache memory. The interface circuitry enables communication between the memory block 110 and the processing block 120, as well as with other memory or processing blocks not shown in FIG. 1A. In some embodiments, the interface circuitry includes a network on chip (NoC), configured to provide interconnections between each memory layer of the stacked memory (112A-112D) via through-silicon vias (TSVs) and each processing core in the processing block 120. The NOC serves as a backbone communication path, connecting nodes such as the computing die (and the processing cores included in the computing die) and the memory layer of the stacked memory. In some examples, a memory controller is connected to the memory layer of the stacked memory, and also the NoC, and the individual layer of the memory layer of the stacked memory may not connect directly to the NoC. The NoC includes routers and switches that handle data routing between processing cores and memory, facilitating efficient communication. These routers and switches are composed of multiple transistors and can be implemented as monolithically integrated router-based switching networks.

In some embodiments, the logic base die 130A can implement a processing unit (e.g., a logic base die processing unit) to manage the communication paths of the NoC (for example, by controlling the router operations of the NoC), such that multiple communication paths can be activated simultaneously, enabling parallel processing by accessing different memory locations concurrently. The NoC can be connected to various data communication standards, such as USR/UCIe interfaces for die-to-die connections, accelerator fabric links for data communication with other AI accelerators or processing units, as well as PCIe interfaces. Any commercially available communication interfaces used for data communication between semiconductor components of an AI accelerator can be implemented in the NoC without limitation. The NoC can implement various network topologies, such as mesh (with a grid-like arrangement of nodes and routers), torus, ring, or fat tree, depending on specific application requirements. For example, in a mesh topology, processing cores, cache memories, and peripheral circuitry (e.g., memory controllers) are connected to routers as nodes, enabling parallel pathways between nodes to optimize data congestion and latency.

The logic base die 130A may also include peripheral circuitry, such as memory controllers, cache coherence circuitry, and MBIST (Memory Built-In Self-Test). Additional circuitry may include access transistors (used to access specific memory locations during read/write operations), clock signal generators (providing timing signals for synchronization between the memory block and processing block), sense amplifiers (detecting and amplifying voltage differences in memory cells), and more. The logic base die 130A can also include cache memory, such as last-level cache (LLC or L3 cache), providing larger capacity but slower speed compared to L1 or L2 caches. In some cases, the logic base die processing unit can control and manage the interface logic for the NoC, various other interfaces, and the operation of peripheral circuitry, including cache coherence, memory access, MBIST, and other related functions.

Generally, the memory controller, NoC, and LLC are based on a technology node having lower scalability relative to a technology node at which the processing block 120 (processing cores and L1/L2 cache memories) is fabricated. Integrating components such as the memory controller, NoC, and LLC on the logic base die 130A, separate from the processing block, is advantageous for increasing the scalability of the processing cores and enhancing data communication performance (lower latency, higher bandwidth, higher speed) between the memory block 110 and processing block 120 via the NoC.

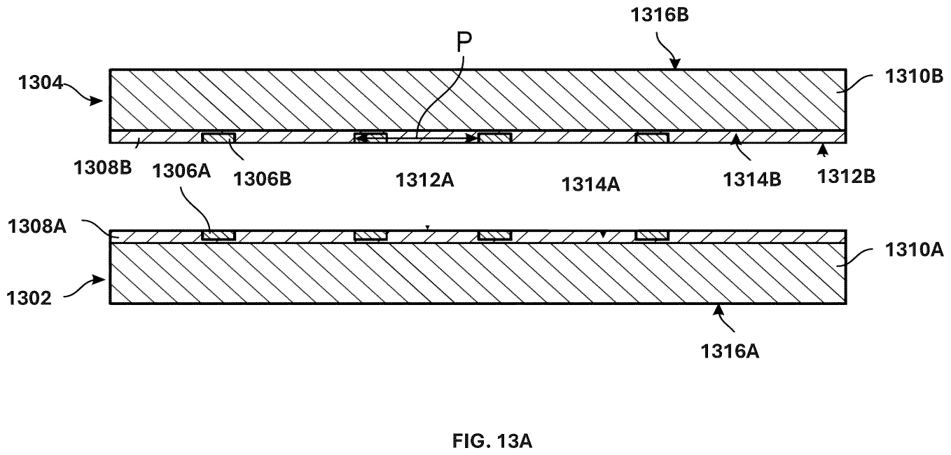

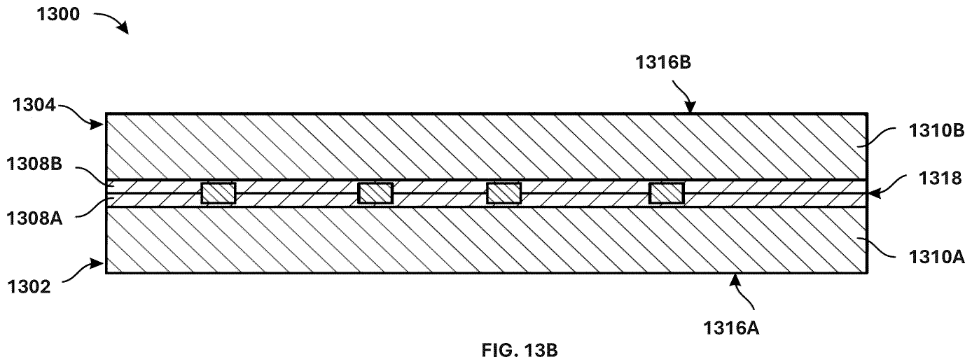

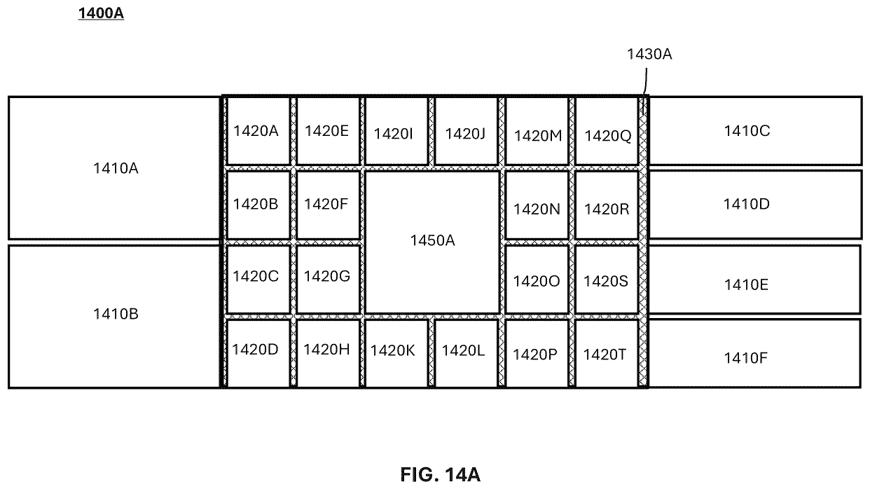

As further shown in FIG. 1A, the memory block 110, processing block 120, and logic base die 130A are disposed on a common substrate 140, which may be a silicon interposer with embedded electrical connections for communicatively coupling the memory block and the processing block (e.g., via the logic base die 130A). The processing block 120 and logic base die 130A can be disposed laterally to each other, heterogeneously integrated and communicatively coupled to each other using die-to-die interfaces like USR/UCIe. They may also be bonded, e.g., direct or hybrid direct bonded to the common substrate 140. The memory block 110 is vertically and directly mounted on the logic base die 130A, so the logic base die is vertically interposed between the substrate 140 and the memory block 110. The memory controller on the logic base die 130A connects to each memory layer of the stacked memory (112A-112D) through via connections. In some cases, the processing block 120 and logic base die 130A are directly bonded to the common substrate without an adhesive layer, for example, by using hybrid bonding techniques (as illustrated in FIGS. 13A and 13B). For example, one or both of the computing die and the logic base die are directly bonded to the substrate by hybrid bonding.

Optionally, the memory block 110 may include a memory logic die 114A, vertically interposed between the stacked memory (112A-112D) and the logic base die 130A. In these embodiments, some peripheral circuitry and/or cache memory included in the logic base die 130A can be integrated into the memory logic die 114A. For example, components like the LLC, memory controller (MC), cache coherence circuitry, and MBIST can be integrated into the memory logic die 114A.

FIG. 1B illustrates an AI accelerator 100B with multiple memory blocks and processing blocks. The AI accelerator 100B includes two memory blocks 110A and 110B, two processing blocks 120A and 120B, a logic base die 130B, and a common substrate 140. The memory blocks 110A and 110B are similar to the memory block 110 in FIG. 1A, and the processing blocks 120A and 120B are similar to the processing block 120.

As illustrated in FIG. 1B, the logic base die 130B is positioned on a central portion 140A of the substrate 140. The two processing blocks, 120A and 120B, are disposed on first portion 140B and second portion 140C of the substrate, respectively, which are opposite each other relative to the central portion 140A.

In some embodiments, each of the memory blocks 110A and 110B is vertically and directly mounted on the logic base die 130B, so that the logic base die is interposed between the memory blocks and the substrate 140 at the central portion 140A. The processing block 120A is positioned on the first portion 140B and is interconnected with the logic base die 130B via electrical connections 150A embedded in the substrate 140. Similarly, the processing block 120B is positioned on the second portion 140C and is interconnected with the logic base die 130B via electrical connections 150B.

In some examples, the processing blocks 120A and 120B and the logic base die 130B are integrated through the electrical connections embedded in the common substrate 140 (e.g., silicon interposer). In some embodiments, the processing blocks 120A, 120B and the logic base die 130B are directly bonded to the substrate 140 without an adhesive layer. In some examples, they may be directly bonded to the substrate using hybrid bonding techniques, as illustrated in FIGS. 13A and 13B. For example, one or both of the computing dies and the logic base die are directly bonded to the substrate by hybrid bonding.

The logic base die 130B can include interface circuitry, peripheral circuitry, and cache memory utilized by the memory blocks 110A and 110B. The interface circuitry is configured to enable communication between the memory blocks 110A and 110B and the processing blocks 120A and 120B, as well as communication between the memory blocks themselves. In some embodiments, the interface circuitry includes a NoC, which provides interconnections between each memory in the stacked memory blocks (112A-112D and 112E-112H) and each computing die in the processing blocks 120A and 120B. These connections may be established through-silicon vias (TSVs) to the corresponding memories.

In some embodiments, the NoC provides a backbone communication path where each processing block can communicate with each memory block and every other processing block. In some examples, a memory controller is connected to the memory layer of the stacked memory and also the NoC, and individual layer of the memory layer of the stacked memory may not connect directly to the NoC. The NoC includes routers and switches that handle data routing between processing cores and memory, facilitating efficient communication. These routers and switches are composed of multiple transistors and can be implemented as monolithically integrated router-based switching networks. For example, the NoC can allow data to be transferred between the processing cores of the processing blocks 120A and 120B and memory layers of the memory blocks 110A and 110B by handling the routing within the NoC. These routers and switches are composed of multiple transistors and may be implemented as networking modules with monolithically integrated router-based switching networks.

The number of nodes in the NoC can be scaled based on the number of processing cores or the number of processing blocks implemented in the AI accelerator. Furthermore, two or more communication paths can be simultaneously activated, enabling parallel processing by the processing cores through simultaneous access to different memory locations in the memory blocks. The NoC can be connected to various data communication standards. For example, it can be connected to USR/UCIe die-to-die interfaces to communicate data with the processing blocks 120A and 120B through the interconnections 150A and 150B, respectively. Moreover, the NoC can be connected to additional interfaces, such as accelerator fabric links and PCIe interfaces, and any commercially available communication interfaces used for data communication between semiconductor components of an AI accelerator.

Additionally, the NoC can implement a mesh topology with a grid-like arrangement of nodes and routers. For example, the processing cores, each level of cache memory, and peripheral circuitry (e.g., memory controllers) can be connected to the routers of the NoC as nodes. The mesh topology enables parallel pathways between nodes, optimizing data congestion and reducing latency. In some embodiments, the NoC can also implement other topologies, such as torus, ring, and fat tree, based on specific application requirements.

The logic base die 130B can include peripheral circuitry and last-level cache (LLC), as described with respect to the logic base die 130A illustrated in FIG. 1A. However, since the memory blocks 110A and 110B are vertically disposed on the logic base die 130B, the logic base die includes multiple peripheral circuits and LLCs, which are individually utilized by each memory block 110A and 110B.

In some embodiments, the hardware resource utilization of the memory blocks 110A and 110B and the processing blocks 120A and 120B can be dynamically allocated. For example, if the AI workload is compute-intensive and may need extensive computation, the processing cores included in both processing blocks 120A and 120B can be utilized such that both processing blocks may access the memory block 110A via the NoC. In cases where the AI workload is memory-intensive and may need extensive use of memory space, the memory blocks 110A and 110B can be utilized for processing the workload, with processing cores in processing block 120A accessing both memory blocks via the NoC.

In some examples, the AI accelerator 100B can perform parallel AI task processing. For instance, the processing cores in the processing blocks 120A and 120B can utilize portions of the memory included in the memory blocks 110A and 110B to process multiple AI workloads simultaneously. Thus, the AI accelerator 100B can handle multiple AI workloads in parallel.

In some embodiments, each memory block 110A, 110B can respectively include memory logic die 114A, 114B. In these embodiments, the memory logic die 114A, 114B can include corresponding peripheral circuitry and LLC. Thus, the logic base die 130B can include the NoC, accelerator fabric links, PCIe express, and USR/UCIe.

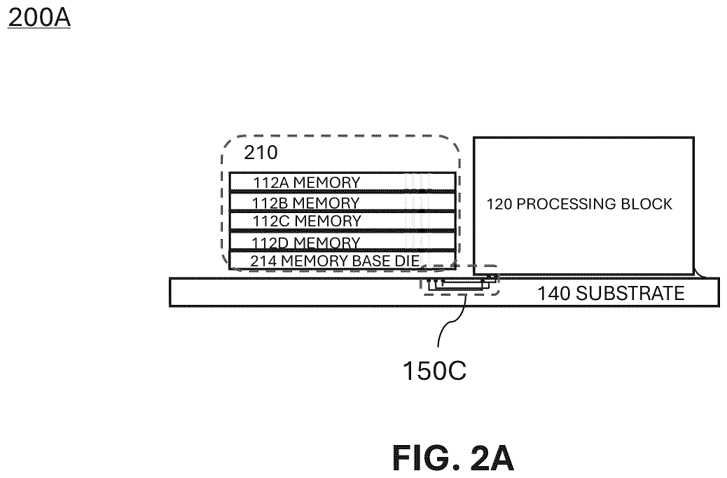

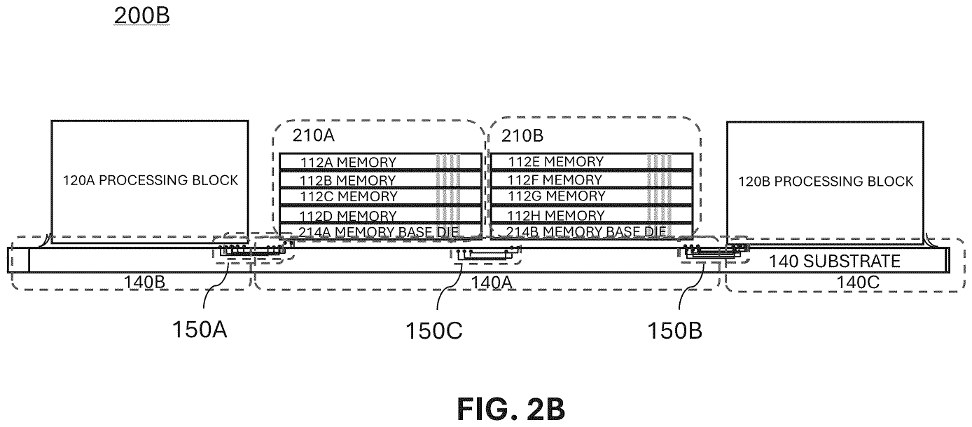

FIG. 2A schematically illustrates a diagram of a novel AI accelerator 200A, according to embodiments disclosed herein. As shown in FIG. 2A, the AI accelerator 200A includes a memory block 210, a processing block 120, and a substrate 140.

As illustrated in FIG. 2A, the memory block 210 includes a stacked memory (112A-112D), which in this example has four layers. Each layer in the stacked memory can be a DRAM. In some embodiments, at least one of the DRAM layers includes circuitry to process data retrieved from its corresponding DRAM, effectively functioning as processing-in-memory (PIM). For instance, one or more memories in the stacked memory can embed processing units or circuitry to process data stored within them. Alternatively, at least one memory layer could be SRAM. The stacked memory may include a combination of DRAM, SRAM, and PIM layers. Although FIG. 2A illustrates four layers, this is merely an example; the number of stacked memory layers is not limited and can be 6, 8, 10, 12, 14, 16, 18, 20, or any number in a range defined these values, or more than 20 layers.

The memory block 210 further includes a memory base die 214, which is disposed vertically below the stacked memory (112A-112D). As further illustrated in FIG. 2A, the AI accelerator 200A also includes the processing block 120, laterally disposed with the memory block 210. The processing block 120 is the same as the processing block 120 illustrated in FIG. 1A.

In some embodiments, the memory base die 214 (included in the memory block 210) can include interface circuitry, peripheral circuitry, and cache memory. The interface circuitry enables communication between the memory block 210 and the processing block 120, as well as with other memory or processing blocks not shown in FIG. 2A. In some embodiments, the interface circuitry includes a NoC, configured to provide interconnections between each memory layer of the stacked memory (112A-112D) via through-silicon vias (TSVs) and each computing die in the processing block 120. The NoC serves as a backbone communication path, connecting nodes such as computing die (and the processing cores included in the computing die) and memory layer of the stacked memory. In some examples, a memory controller is connected to the memory layer of the stacked memory and also the NoC, and individual layer of the memory layer of the stacked memory may not connect directly to the NoC. The NOC includes routers and switches that handle data routing between processing cores and memory, facilitating efficient communication. These routers and switches are composed of multiple transistors and can be implemented as monolithically integrated router-based switching networks. Multiple communication paths can be activated simultaneously, enabling parallel processing by accessing different memory locations concurrently.

The NoC can also be connected to various data communication standards, such as USR/UCIe interfaces for communication with the processing block 120. It may also be connected to additional interfaces, such as accelerator fabric links for data communication with other AI accelerators or processing units, as well as PCIe interfaces. Any commercially available communication interfaces used for data communication between semiconductor components of an AI accelerator can be implemented with the NoC without limitation. The NoC can also implement various network topologies, such as mesh (with a grid-like arrangement of nodes and routers), torus, ring, or fat tree, depending on specific application requirements. For example, in a mesh topology, processing cores, cache memories, and peripheral circuitry (e.g., memory controllers) are connected to routers as nodes, enabling parallel pathways between nodes to optimize data congestion and latency.

The memory base die 214 may also include peripheral circuitry, such as memory controllers, cache coherence circuitry, and MBIST (Memory Built-In Self-Test). Additional circuitry may include access transistors (used to access specific memory locations during read/write operations), clock signal generators (providing timing signals for synchronization between the memory block and processing block), sense amplifiers (detecting and amplifying voltage differences in memory cells), and more. The memory base die 214 can also include cache memory, such as last-level cache (LLC or L3 cache), offering larger capacity but slower speed compared to L1 or L2 caches.

Generally, the memory controller, NoC, and LLC are configured with transistors having a larger scaling factor (i.e., less advanced process node) than those used in the processing block 120 (processing cores and L1/L2 cache memories). Integrating components like the memory controller, NoC, and LLC on the memory base die 214, separate from the processing block, is advantageous for increasing the scalability of the processing cores and enhancing data communication performance (lower latency, higher bandwidth, higher speed) between the memory block 210 and processing block 120 via the NoC.

As further shown in FIG. 2A, the memory block 210 and processing block 120 are disposed on a common substrate 140, which may be a silicon interposer with embedded electrical connections 150C for electrically connecting the memory block and processing block (e.g., via the memory base die 214). The processing block 120 and the memory block 210 (e.g., the memory base die 214) can be heterogeneously integrated, disposed laterally to each other, and communicatively connected to each other using die-to-die interfaces such as USR/UCIe. In some cases, the processing block 120 and the memory block 210 (e.g., the memory base die 214) are directly bonded to the common substrate without an adhesive layer, for example, by using hybrid bonding techniques (as illustrated in FIGS. 13A and 13B). For example, one or both of the processing block and the memory block (e.g., memory base die) are directly bonded to the substrate by hybrid bonding.

FIG. 2B illustrates an AI accelerator 200B with multiple memory blocks and processing blocks. The AI accelerator 200B includes two memory blocks 210A and 210B, two processing blocks 120A and 120B, and a common substrate 140. The memory blocks 210A and 210B are similar to the memory block 210 in FIG. 2A, and the processing blocks 120A and 120B are similar to the processing block 120 illustrated in FIGS. 1A and 2A.

As illustrated in FIG. 2B, the memory blocks 210A and 210B are positioned on a central portion 140A of the substrate 140. The two processing blocks, 120A and 120B, are disposed on first portion 140B and second portion 140C of the substrate, respectively, which are opposite each other relative to the central portion 140A.

In some embodiments, each of the memory blocks 210A and 210B includes stacked memory (112A-112D) and (112E-112H), vertically stacked on corresponding memory base dies 214A and 214B, respectively. Each memory base die 214A and 214B includes a NoC, as described above with respect to FIG. 2A. For example, the NoC included in the memory base die 214A can provide data network paths and routers connected to the electrical connections 150A that connect to the processing cores of the processing block 120A. Likewise, the NoC included in the memory base die 214B can provide data network paths and routers connected to the electrical connections 150B that connect to the processing cores of the processing block 120B.

In some embodiments, the memory blocks 210A and 210B are also communicatively coupled via the NoCs included in the memory base dies 214A and 214B, and the electrical connections 150C. For example, the electrical connections 150C can provide electrical interconnections between the network paths included in the NoCs of memory base dies 214A and 214B.

In some examples, the electrical connections between the memory base dies 214A and 214B via the electrical connections 150C can enable the dynamic allocation of the hardware resources of the AI accelerator 200B. For example, if the AI workload is compute-intensive and may need extensive computation, the processing cores included in both processing blocks 120A and 120B can be utilized such that both processing blocks may access the memory block 210A via the NoCs in the memory base dies 214A and 214B and the electrical connections 150C. In cases where the AI workload is memory-intensive and may need extensive use of memory space, the memory blocks 210A and 210B can be utilized for processing the workload, with processing cores in processing block 120A accessing both memory blocks via the NoCs in the memory base dies 214A and 214B and the electrical connections 150C. For example, the processing block 120A can utilize the memory resource of the memory block 210B by accessing the memory of the memory block 210B via the electrical connection 150A, the NoC of memory base die 214A, the electrical connection 150C, the NoC of memory base die 214B, and the memory controller included in the memory base die 214B. The NoCs included in memory base dies 214A and 214B collectively form a NoC of the AI accelerator 200B.

In some examples, the AI accelerator 200B can perform parallel AI task processing. For instance, the processing cores in the processing blocks 120A and 120B can utilize portions of the memory included in the memory blocks 210A and 210B to process multiple AI workloads simultaneously by accessing these portions of memory simultaneously, utilizing the electrical connection 150A, the NoC of memory base die 214A, the electrical connection 150C, the NoC of memory base die 214B, and the electrical connection 150B. In some cases, the processing blocks 120A, 120B and the memory blocks 210A, 210B (e.g., the memory base dies 214A, 214B) are directly bonded to the common substrate without an adhesive layer, for example, by using hybrid bonding techniques (as illustrated in FIGS. 13A and 13B). For example, one or more of the processing blocks 120A, 120B and the memory block (e.g., memory base dies 214A, 214B) are directly bonded to the substrate by hybrid bonding.

### Example of Processing Block

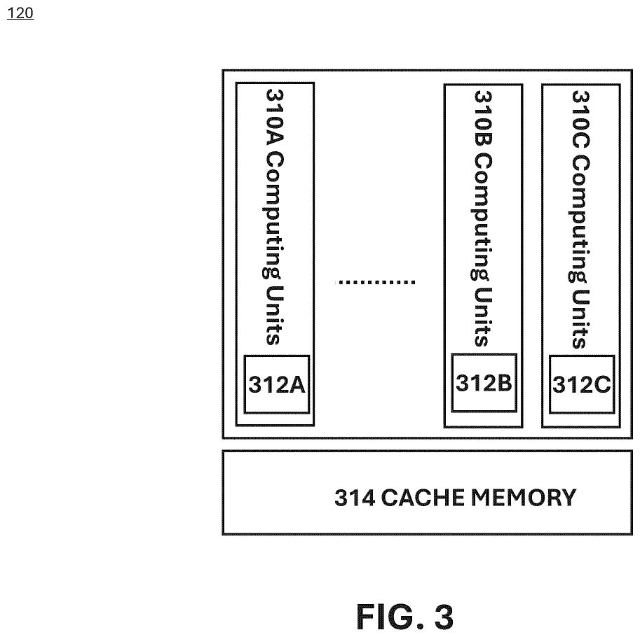

FIG. 3 illustrates a block diagram of the processing block 120, according to embodiments disclosed herein. As shown in FIG. 3, the processing block 120 can include one or more computing units (e.g., computing units 310A-310C) and a cache memory block 314.

In some embodiments, each computing units 310A-310C includes a plurality of parallel processing cores configured to execute instructions for processing AI workloads. These processing cores may include, without limitation, GPU cores, TPU cores, and NPU cores, and they are designed to process AI workloads in parallel (or simultaneously). In some examples, the processing block 120 may include one or more computing units, having GPU cores, or it may include two or more computing units with a combination of GPU, TPU, or NPU cores. The specific combination can be determined based on application requirements, and the present disclosure does not limit the types or numbers of cores used. Although certain numbers of computing units are illustrated in FIG. 3, this is merely an example, and the processing block 120 can include any suitable number of computing units.

As further shown in FIG. 3, each computing units 310A-310C includes a cache memory 312A-312C, respectively. In some embodiments, the cache memories 312A-312C are L1 cache memories, providing faster data access to the corresponding processing cores.

The processing block 120 can also include a lower-level cache memory 314, such as an L2 cache memory, to provide instructions and data to the computing units 310A-310C.

In some examples, each computing units 310A-310C can be electrically connected to the memory block via a network on chip (NoC) included in a logic base die (as shown in FIG. 1A) or within the memory block (as shown in FIG. 2A).

### Example of Processing Block With Back Side Power Delivery Network

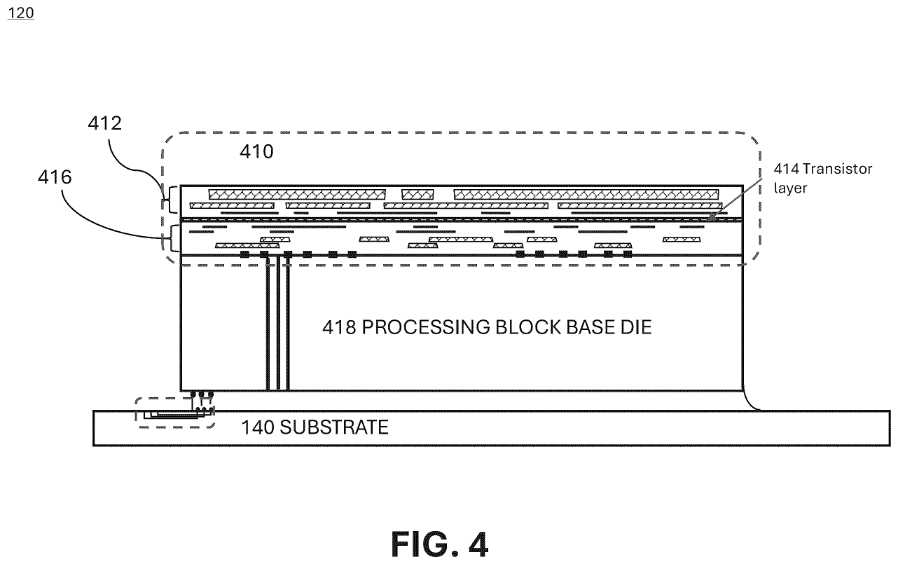

FIG. 4 illustrates a diagram of the processing block 120 with a back side power delivery network (BSPDN), according to embodiments disclosed herein. As shown in FIG. 4, the processing block 120 includes a computing die 410, which is a multi-layered structure, including a BSPDN.

The computing die 410 can include three layers stacked vertically: the BSPDN layer 412, the transistor layer 414, and the signal interconnection layer 416. The BSPDN layer 412, positioned at the top, is utilized for efficiently delivering power to the transistor layer beneath it. This layer contains a multitude of power lines (e.g., VDD and VSS rails) connected directly to the corresponding power terminals of the transistor layer 414. By delivering power from the back side, the BSPDN reduces voltage drop (IR drop) and improves power integrity, allowing for higher performance and reduced heat generation. This method separates power delivery from signal routing, minimizing interference and enhancing overall efficiency.

As further illustrated in FIG. 4, the transistor layer 414 is positioned between the BSPDN layer and the signal interconnection layer, and the transistor layer 414 includes array of transistors that form one or more processing cores of the AI accelerator. These transistors can be scaled to enable high transistor density and performance. In some cases, cache memory such as L1 cache is also integrated within the transistor layer 414, closely coupled with the processing cores to provide rapid access to frequently used data and instructions. The integration of cache memory at this layer reduces latency and improves computational efficiency.

In addition, the signal interconnection layer 416 is located beneath the transistor layer 414 and consists of multiple metal interconnect layers mainly used for signal routing. This layer includes a multitude of signal paths (e.g., metal wires, vias) that connect the input/output terminals of the transistors in the transistor layer to other components within the processing block or to external interfaces. The signal interconnection layer 416 can be designed to handle high-speed data transmission with minimal signal loss or crosstalk, ensuring efficient communication within the AI accelerator.

By vertically stacking these layers—with the transistor layer 414 sandwiched between the BSPDN layer 412 and the signal interconnection layer 416—the design can achieve optimal separation of power and signal pathways. This configuration enhances the overall performance and reliability of the processing block by reducing electromagnetic interference and improving thermal management.

As further illustrated in FIG. 4, a processing block base die 418 is interposed between the computing die 410 (specifically, the signal interconnection layer 416) and the substrate 140. The processing block base die 418 serves as an interface layer that facilitates communication between the computing die 410 and other components of the AI accelerator, such as memory blocks or logic base dies. The signal interconnection layer 416 and the processing block base die 418 are three-dimensionally bonded using hybrid bonding techniques (as illustrated in FIGS. 13A and 13B).

In some examples, the processing block base die 418 is configured to provide interfaces for connecting with memory blocks via high-speed interconnect standards such as USR or UCIe. These interfaces enable die-to-die communication without the need for intermediary PHY layer encoding or decoding, which reduces latency and power consumption. Utilizing USR/UCIe interfaces instead of traditional PHY layer interfaces enhances the scalability of interconnections and supports higher data rates, benefiting applications that demand high bandwidth and low latency. In some embodiments, the processing block base die 418 can be communicatively coupled with the NoC (e.g., provided by the logic base die 130A (as illustrated in FIG. 1A) or the memory base die 214 (as illustrated in FIG. 2A)) via the USR or UCIe interface.

### Examples of Memory-centric AI Accelerator Architecture

FIGS. 5A-5D illustrate various examples of memory-centric AI accelerator architectures, according to embodiments disclosed herein. This memory-centric AI accelerator architecture is designed to increase the performance of the AI accelerator by efficiently dissipating heat generated from the processing blocks, preventing heat accumulation in the central portion of the accelerator. For illustrative purposes, components depicted in FIGS. 5A-5D correspond to those illustrated in FIGS. 1A-4.

FIG. 5A illustrates a block diagram illustrating an example of a memory-centric AI accelerator architecture 500A, including multiple memory blocks 110AA-110HH, multiple processing blocks 120AA-120FF, and NoC 530A connected to the memory blocks (e.g., 120AA-120FF) and the processing blocks (e.g., 110AA-110HH), facilitating signal routing between them. In some embodiments, L3 and/or LLC cache memory can also be integrated with the NoC and communicatively coupled between the memory blocks and the processing blocks. The memory blocks 110AA-110HH can correspond to the memory block 110 (e.g., FIG. 1A, where a memory block comprising stacked memory with or without a memory base die). The processing blocks 120AA-120FF correspond to the processing block 120 illustrated in FIGS. 1A-4. In some embodiments, the memory blocks 110AA-110HH can be vertically (e.g., and directly) stacked on the logic base die (e.g., logic base die 130A, 130B shown in FIGS. 1A and 1B). In these embodiments, The NoC and L3/LLC cache memory can be implemented in the logic base dies 130A, 130B. In some embodiments, each memory block (110AA-110HH) can be vertically (e.g., and directly) stacked on a corresponding memory base die (e.g., memory base die 214, 214A, 214B shown in FIGS. 2A-2B). In these embodiments, the memory base dies 214, 214A, and 214B can include the NoC and L3/LLC cache memory. In some examples, the NoC 530A can be connected to various data communication standards, such as USR/UCIe interfaces for chiplets interconnection (e.g., USR/UCIe 550 between a processing block and a logic base die or a memory base die), accelerator fabric links for data communication with other AI accelerators or processing units, as well as PCIe interfaces.

While FIG. 5A illustrates a functional block diagram of the memory-centric AI accelerator architecture 500A, the general positions of the processing blocks and memory blocks can represent their relative positions relative to an underlying substrate (not shown). For example, adjacent to the first edge of the substrate (first portion 510A), an array of processing blocks 120AA-120CC is disposed in a single-column arrangement. Similarly, adjacent to the second edge of the substrate (second portion 510C), another array of processing blocks 120DD-120FF is arranged in a single column. Thus, the first column of memory blocks 110AA-110DD is laterally adjacent to the processing blocks 120AA-120CC on the first portion 510A, while the second column of memory blocks 110EE-110HH is laterally adjacent to the processing blocks 120DD-120FF on the second portion 510C.

The NoC 530A can interconnect the memory blocks 110AA-110HH and processing blocks 120AA-120FF, facilitating signal routing between them. The substrate 540 incorporates embedded interconnections 550, providing electrical connections from each processing block to the NoC.

These routers and switches can be controlled by a processing unit embedded within the NoC 530A, such as a NoC processing unit configured to manage data path configurations by controlling routing and switching operations. The connections between each processing block and the NOC utilize USR or UCIe interfaces. This configuration facilitates high-bandwidth, low-latency communication between processing and memory components.

The NoC 530A also provides various interfaces, such as accelerator fabric links for data communication with other AI accelerators or processing units, as well as PCIe interfaces for external connectivity. Additionally, the NoC can include cache memory, such as last-level cache (LLC or L3 cache), implemented using conventional SRAM configurations. Peripheral circuitry within the NoC may include memory controllers, cache coherence circuitry, and Memory Built-In Self-Test (MBIST) components.

The NoC and L3/LLC cache memory communicatively coupled between the processing blocks, and the memory blocks enable dynamic allocation of resources within the AI accelerator 500A. For example, in compute-intensive AI workloads requiring extensive computation, multiple processing blocks (e.g., 120AA-120CC) can access a single memory block (e.g., 110AA) via the NoC in the logic base die. Conversely, in memory-intensive workloads requiring extensive memory space, multiple memory blocks (e.g., 110AA-110DD) can be utilized by a single processing block (e.g., 120AA) through the NoC, allowing for flexible resource allocation based on workload demands.

FIG. 5B illustrates an example of a memory-centric AI accelerator 500B, including multiple logic base dies 130AA-130DD (e.g., logic base dies 130A and 130B in FIGS. 1A-1B) and multiple processing blocks 120GG-120JJ (e.g., processing block 120, 120A, and 120B in FIGS. 1A-1B). There are single or multiple memory blocks (e.g., memory blocks 110, 110A, and 110B in FIGS. 1A-1B, not shown in FIG. 5B) three-dimensionally stacked on each of the logic base dies 130AA-130DD. In this embodiment, the logic base dies together with the memory blocks that are three-dimensionally (and vertically) stacked on the corresponding logic base dies are implemented in the central portion 510B of the substrate 540, arranged in a 2×2 array. Processing blocks 120GG-120HH are disposed on the first portion 510A adjacent to the first edge of the substrate, while processing blocks 120II-120JJ are disposed on the second portion 510C adjacent to the second edge. The arrangement of memory blocks are illustrated as examples, and the present disclosure does not limit the arrangement of the memory blocks, for the example, the memory blocks can be arranged based on specific applications, such as 1×2, 2×1, 1×3, 3×1, 2×3, 3×2, 3×3, and the like.

In some embodiments, each of the logic base dies 130AA-130DD include NoC that are connected to the corresponding memory blocks (e.g., memory blocks vertically stacked on the logic base die) and the corresponding processing blocks, facilitating signal routing between them. The logic base dies 130AA-130DD may also include L3 and/or LLC cache memory communicatively coupled between the memory blocks and the processing blocks. Each processing block is connected to the adjacent logic base die using USR/UCIe interfaces via electrical connections 524 embedded in the substrate 540.

In some embodiments, the logic base dies 130AA-130DD are connected using USR/UCIe interfaces via electrical connections 526 embedded in the substrate 540, enabling communication between the NoCs of adjacent logic base dies. The NoC functions distributed in the multiple logic base dies collectively form a NoC of the AI accelerator 500B. The NoC also provides connections and enables efficient data sharing and communication between memory blocks. The NoC may include a plurality of routers (implemented as transistor switches) to manage data communication paths between processing blocks and memory blocks, as well as between memory blocks themselves. A logic base die processing core within the logic base die(s) can manage the routing operations of the NoC. The logic base die may also include various interfaces, such as accelerator fabric links and PCIe interfaces 522.

Dynamic allocation of hardware resources is facilitated by the NoC and cache memories communicatively coupled between the processing blocks and the memory blocks. For compute-intensive workloads, multiple processing blocks (e.g., 120GG-120JJ) can access one or more memory blocks stacked on a single logic base die (e.g., 130AA) via the NoC in the logic base die. For memory-intensive workloads and memory blocks stacked on multiple logic base dies (e.g., 130AA-130DD) can be utilized by a single processing block (e.g., 120HH) through the NoC, allowing the AI accelerator 500B to adapt to varying computational demands. The processing blocks are connected through the NoC. There may additionally be die-to-die connections between adjacent processing blocks using USR/UCIe interfaces via electrical connections 528 embedded in the substrate 540. Such connections enable efficient communication between processing blocks for the power efficiency of processing compute-intensive workloads.

FIG. 5C illustrates another example of a memory-centric AI accelerator 500C, including multiple memory blocks 210AA-210DD and processing blocks 120KK-120NN. The memory blocks, each including a memory base die as illustrated in FIG. 2A, are implemented in the central portion 510B of the substrate 540 (e.g., substrate 140 in FIGS. 1A-4), arranged in a single column of four rows. Processing blocks 120KK-120LL are disposed on the first portion 510A adjacent to the first edge of the substrate, while processing blocks 120MM-120NN are disposed on the second portion 510C adjacent to the second edge.

Each processing block is connected to two corresponding memory blocks via die-to-die connection using USR/UCIe interfaces. The substrate 540 incorporates embedded electrical connections 532, enabling the processing blocks to connect to the NoCs included in the memory base dies of the memory blocks. Specifically, processing block 120KK connects to memory blocks 210AA and 210BB; processing block 120LL connects to memory blocks 210CC and 210DD; processing block 120MM connects to memory blocks 210AA and 210BB; and processing block 120NN connects to memory blocks 210CC and 210DD.

Memory blocks are connected using USR/UCIe interfaces via electrical connections 534 embedded in the substrate 540, enabling communication between the NoCs of adjacent memory base dies. The NoC functions distributed in the memory base dies of the multiple memory blocks 210AA-210DD collectively form a NoC of the AI accelerator 500C. The accelerator fabric links and PCIe interfaces 522 may be implemented in some of the memory base dies of the multiple memory blocks 210AA-210DD.

Dynamic allocation of hardware resources is facilitated through the NoC and cache memories communicatively coupled between the processing blocks and memory blocks. For compute-intensive workloads, multiple processing blocks (e.g., 120KK-120NN) can access a single memory block (e.g., 210AA) via the NoC in the memory base die. For memory-intensive workloads, multiple memory blocks (e.g., 210AA-210BB) can be utilized by a single processing block (e.g., 120KK) through the NoCs, allowing the AI accelerator 500C to efficiently adapt to workload requirements. The processing blocks are mainly connected through the NoC. There may be die-to-die connections between adjacent processing blocks using USR/UCIe interfaces via electrical connections 538 embedded in the substrate 540. Such connections enable efficient communication between processing blocks for the power efficiency of processing compute-intensive workloads.

FIG. 5D illustrates another example of a memory-centric AI accelerator 500D, including multiple memory blocks 210EE-210HH and processing blocks 120OO-120PP. The memory blocks, each including a memory base die as illustrated in FIG. 2A, are implemented in the central portion 510B of the substrate 540, arranged in a 2×2 array. Processing block 120OO is disposed on the first portion 510A adjacent to the first edge of the substrate, while processing block 120PP is disposed on the second portion 510C adjacent to the second edge.

Each processing block is connected to two corresponding memory blocks via die-to-die connection using USR/UCIe interfaces. The substrate 540 incorporates embedded electrical connections 542, enabling processing block 120OO to connect to memory blocks 210EE and 210GG, and processing block 120PP to connect to memory blocks 210FF and 210HH.

Memory blocks are connected using USR/UCIe interfaces via electrical connections 544 embedded in the substrate 540, enabling communication between the NoCs of the memory base dies. The NoC functions distributed in the memory base dies of the multiple memory blocks 210EE-210HH collectively form a NoC of the AI accelerator 500D. Some of the memory base dies may include accelerator fabric links and PCIe interfaces that are also connected to the NoC.

Dynamic allocation of hardware resources is facilitated through the NoC and cache memories communicatively coupled between the processing blocks and memory blocks. For compute-intensive workloads, multiple processing blocks (e.g., 120OO-120PP) can access a single memory block (e.g., 210EE) via the NoC in the memory base die. For memory-intensive workloads, multiple memory blocks (e.g., 210EE-210HH) can be utilized by a single processing block (e.g., 120PP) through the NoCs, allowing the AI accelerator 500D to efficiently adapt to varying computational demands.

In each of these architectures, the use of USR/UCIe interfaces and NoC configurations enables high-bandwidth, low-latency communication between processing blocks and memory blocks. The ability to dynamically allocate resources based on workload requirements enhances the efficiency and versatility of the AI accelerator. By integrating peripheral circuitry, cache memory, and advanced interconnect technologies, these embodiments provide scalable and high-performance solutions for AI processing tasks.

### Example of Memory Block Configuration

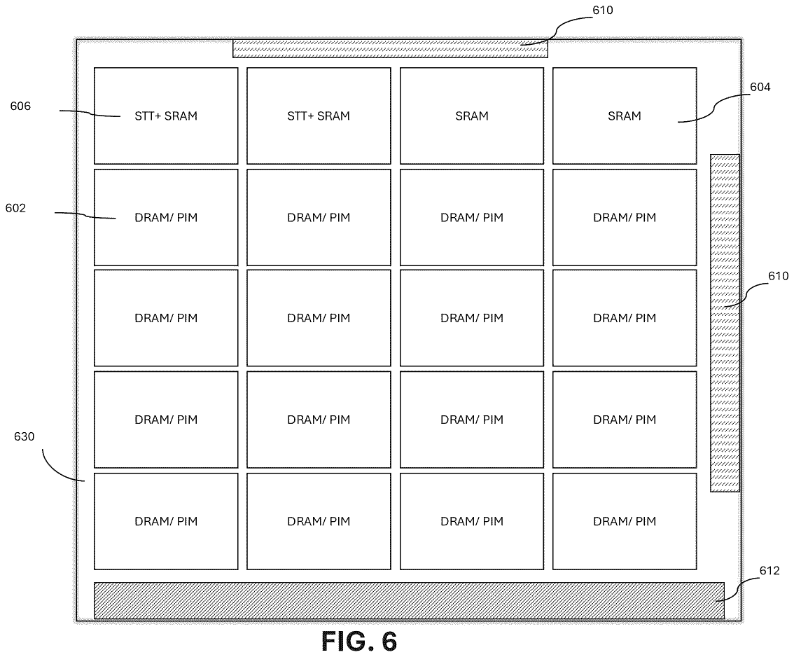

FIG. 6 illustrates an example of a memory block configuration having multiple stacked memories vertically arranged on a logic base die 630. As depicted in FIG. 6, an array of stacked memories is vertically integrated onto the logic base die 630. Specifically, FIG. 6 shows a 4×4 array of stacked memories, resulting in a total of 16 stacked memory units vertically assembled on the logic base die 630. For example, the array of stacked memories is 3 dimensionally integrated on the logic base die 630 by utilizing direct bonding, such as the hybrid bonding (as illustrated in FIGS. 13A and 13B). The arrangement of memory blocks, the 4×4 array of stacked memories, is illustrated as examples, and the present disclosure does not limit the arrangement of the memory blocks.

In some embodiments, the array of vertically stacked memories comprises various memory configurations to optimize performance and adaptability for different applications. For example, the vertically stacked memories may include a combination of DRAM and PIM, as indicated by the stacked memories 602. The DRAM layers provide high-density storage, while the PIM units incorporate computational capabilities directly within the memory architecture, enabling data processing to occur closer to where data is stored. This integration reduces data movement and latency, enhancing overall system efficiency.

Additionally, the array of stacked memories can include stacked SRAM, as shown by the stacked memories 604. SRAM provides faster access times compared to DRAM due to its simpler internal structure, which does not need periodic refreshing. Incorporating SRAM into the stacked memory array allows for rapid data retrieval and is beneficial for applications requiring high-speed memory access.

The array may also incorporate stacked Spin-Transfer Torque Magneto-Resistive Random Access Memory (STT-MRAM), as depicted by the stacked memories 606. STT-MRAM is a non-volatile memory technology that utilizes electron spin states to store data. It offers advantages such as non-volatility, high endurance, and fast read/write speeds. By integrating STT-MRAM into the memory stack, the system benefits from persistent storage capabilities without sacrificing performance. The stacked memories 606 may include optional SRAM at the bottom of the stack. The SRAM can function as a data buffer and high speed interface between the STT-MRAM stack and the logic base die 630.

As further illustrated in FIG. 6, the logic base die 630 provides various interface circuitry for facilitating communication between the memory blocks and processing units. The logic base die includes a NoC, which can function as an interconnection framework enabling efficient data transfer. The NoC is connected to USR or UCIe 610 and accelerator fabric links 612. The NoC is configured to enable communication between each stacked memory unit of the memory block and the processing block, such as processing block 120 illustrated in FIGS. 1A-4. In some embodiments, the NoC provides interconnections between each memory layer of the stacked memories via TSVs and each computing die in the processing block. The TSVs are vertical electrical connections passing through the silicon die, allowing for high-density, high-speed interconnects between stacked layers. In some embodiments, the NoC functions as a backbone communication pathway, connecting various nodes within the system, including processing cores included in the processing block, stacked memory units, and memory controllers connected to the stacked memories. In some configurations, a memory controller is connected to the NoC, serving as an intermediary between the individual memory units and the NoC. This architecture allows individual memories to interface with the NoC indirectly through the memory controller, simplifying the overall design and improving scalability. The NoC incorporates routers and switches that manage data routing between processing nodes and memory units, facilitating efficient and reliable communication. These routers and switches are composed of numerous transistors and can be implemented as monolithically integrated router-based switching networks on the logic base die 630. The monolithic integration of these components enhances signal integrity and reduces latency by minimizing interconnect lengths.

In certain embodiments, multiple communication paths within the NOC can be activated simultaneously, enabling parallel processing by accessing different memory locations concurrently. For example, each stacked memory unit can be accessed in parallel with other stacked memories, allowing for high throughput and improved system performance in data-intensive applications.

The NoC can be connected to various data communication standards. For instance, it can be connected to USR/UCIe interfaces 610 for high-speed communication with the processing block 120. USR and UCIe interfaces enable efficient die-to-die communication without the need for complex PHY layer encoding and decoding, reducing latency and power consumption. The NoC may also be connected to additional interfaces, such as accelerator fabric links 612 for data communication with other AI accelerators or external processing units, as well as PCIe interfaces for broader system integration.

Any commercially available communication interfaces used for data communication between semiconductor components of an AI accelerator can be connected to the NoC without limitation. This flexibility allows the system to adapt to various protocols and standards as required by specific applications.

The NoC can implement various network topologies based on application requirements, such as mesh, torus, ring, or fat tree configurations. In a mesh topology, for example, the nodes—including processing cores, cache memories, and peripheral circuitry like memory controllers—are connected in a grid-like arrangement. This setup enables multiple parallel pathways between nodes, optimizing data congestion and reducing latency. The mesh topology is particularly advantageous for scalable systems where the number of nodes can vary.

The logic base die 630 may also include peripheral circuitry for memory operation and system reliability. This circuitry can encompass memory controllers, cache coherence circuits, and MBIST modules. Memory controllers manage data flow between the memory units and other system components, while cache coherence circuits ensure data consistency across different cache levels and processing units. MBIST modules facilitate testing and verification of memory components during manufacturing and operation, improving yield and reliability.

Furthermore, the logic base die 630 may integrate cache memory, such as LLC or L3 cache, providing larger capacity but with slightly increased latency compared to lower-level caches. The LLC serves as a shared cache resource for multiple processing cores, reducing memory access times for frequently used data and instructions.

By vertically stacking various types of memories on the logic base die 630 and integrating the NoC in the logic base die 630, the architecture illustrated in FIG. 6 can provide a highly flexible and scalable solution for AI accelerators and other high-performance computing applications. The combination of DRAM, SRAM, PIM, and STT-RAM within the memory stack allows the system to balance speed, capacity, non-volatility, and computational capabilities according to specific workload requirements. The integration of the NoC in the logic base die and its compatibility with multiple communication standards ensure that data movement within the system is efficient and adaptable, accommodating the demands of complex AI algorithms and large-scale data processing tasks. This architecture provides a foundation for developing advanced semiconductor devices that meet the increasing performance and efficiency requirements of modern computing applications.

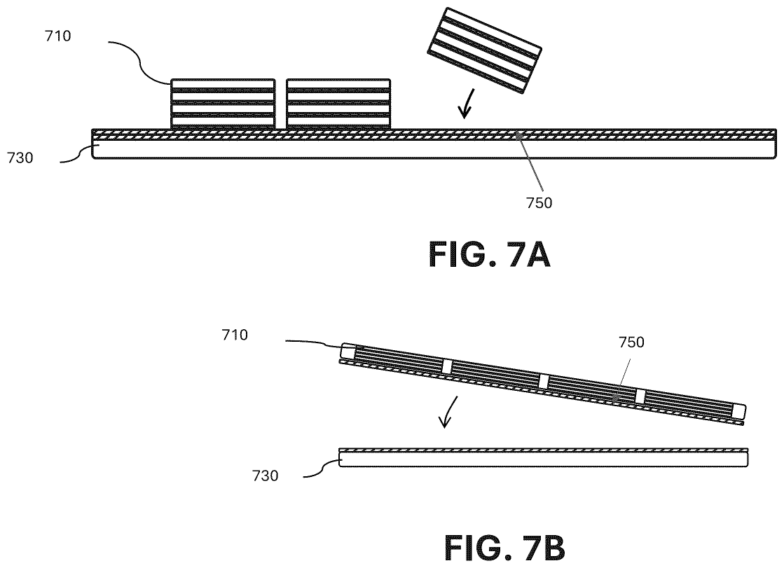

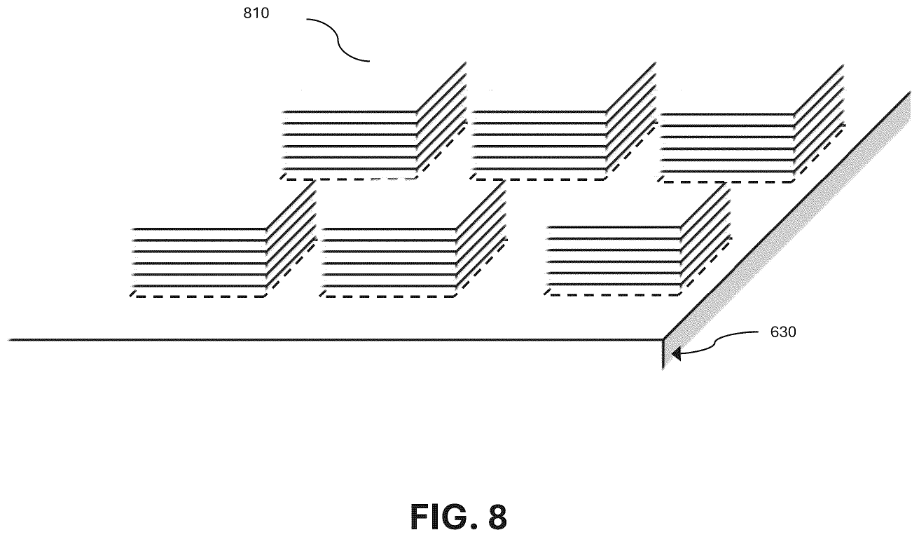

FIGS. 7A-7B and FIG. 8 illustrate embodiments of AI accelerator, implementing redistributed layers in memory block configurations for AI accelerators. These configurations enable efficient integration of stacked memories onto a logic base die, facilitating high-density interconnections, and improved electrical performance.

FIGS. 7A and 7B illustrate various examples of AI accelerator, implementing a redistributed layer (RDL) on the memory block shown in FIG. 6, according to embodiments disclosed herein. For illustrative purposes, the stacked memory is represented as 710, and this stacked memory 710 can be any configuration of stacked memory shown in FIG. 6. For example, the stacked memory 710 can be any of the stacked memories 602, 604, or 606.

In some embodiments, as illustrated in FIG. 7A, the RDL 750 is formed on the logic base die wafer 730 that comprises the logic base dies 630 shown in FIG. 6, specifically on the top surface of the logic base die. Stacked memory's 710 are bonded to the RDL 750 disposed on the logic base die wafer 730 in a die-to-wafer bonding process. The RDL 750 serves to redistribute electrical connections from the densely packed transistors of the stacked memory 710 to the logic base die 630. This configuration facilitates efficient electrical interconnection between the stacked memory and the logic base die, enabling high-density integration and improved signal integrity.

In other embodiments, as illustrated in FIG. 7B, the RDL 750 is formed on a re-constituted wafer with stacked memory's 710. The re-constituted wafer with RDL 750 is then bonded to a logic base die wafer 730 in a wafer-to-wafer bonding process. The logic base die wafer 730 and the RDL 750 are bonded via direct bonding techniques, such as hybrid bonding (as illustrated in FIGS. 13A and 13B). The RDL 750 redistributes the electrical connections from the stacked memory 710 to align with the interconnect structures of the logic base die 630 distributed in the logic base die wafer 730, allowing for efficient signal routing and power delivery between the two components.

The implementation of the RDL provides design flexibility. It allows for the accommodation of various stacking arrangements and memory technologies while ensuring optimal electrical performance. The use of RDLs facilitates the integration of memory stacks with different pad configurations and densities by adjusting the interconnect pathways to match the logic base die's requirements.

FIG. 8 illustrates a three-dimensional view of the memory block configuration depicted in FIG. 6, according to embodiments disclosed herein. For illustrative purposes, the stacked memory is represented as 810, which can be any configuration of stacked memory shown in FIG. 6, such as the stacked memories 602, 604, or 606. As illustrated in FIG. 8, each stacked memory 810 is vertically bonded onto the logic base die 630 via direct bonding techniques, such as hybrid bonding (as illustrated in FIGS. 13A and 13B). This vertical integration enables high-density stacking of memory units on the logic base die, enhancing the overall memory capacity and performance of the AI accelerator.

The direct bonding process, such as hybrid bonding (as illustrated in FIGS. 13A and 13B), allows for strong mechanical and electrical connections between the stacked memory 810 and the logic base die 630 without the need for solder bumps or adhesive layers. This results in lower electrical resistance, higher interconnect density, and improved thermal conductivity.

In these configurations, the RDLs are configured to redistribute the electrical connections to facilitate high-density interconnects and efficient signal routing between the stacked memory and the logic base die. The RDLs are fabricated using advanced lithography and metallization processes to create fine-pitch interconnects capable of supporting high-bandwidth communication. Materials used for the RDLs may include copper or other suitable conductive metals, and they may be encapsulated with dielectric materials to ensure electrical isolation and maintain signal integrity.

By employing RDLs in conjunction with direct bonding techniques (as illustrated in FIGS. 13A and 13B), the integration of the stacked memories onto the logic base die achieves improved electrical performance and a reduced form factor. This approach allows for greater flexibility in the design and layout of the memory block, enabling the incorporation of various memory technologies such as DRAM, SRAM, PIM, or STT-RAM, as described with respect to FIG. 6.

### Example of Three Dimensional AI Accelerator Architecture

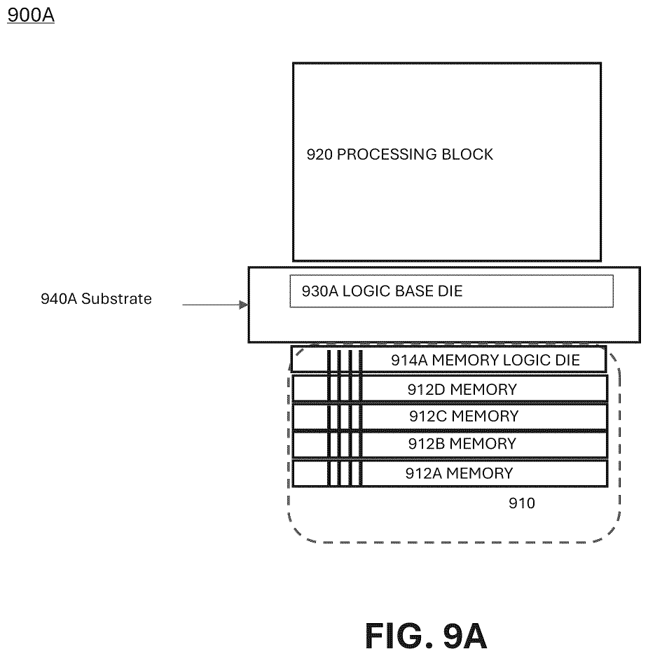

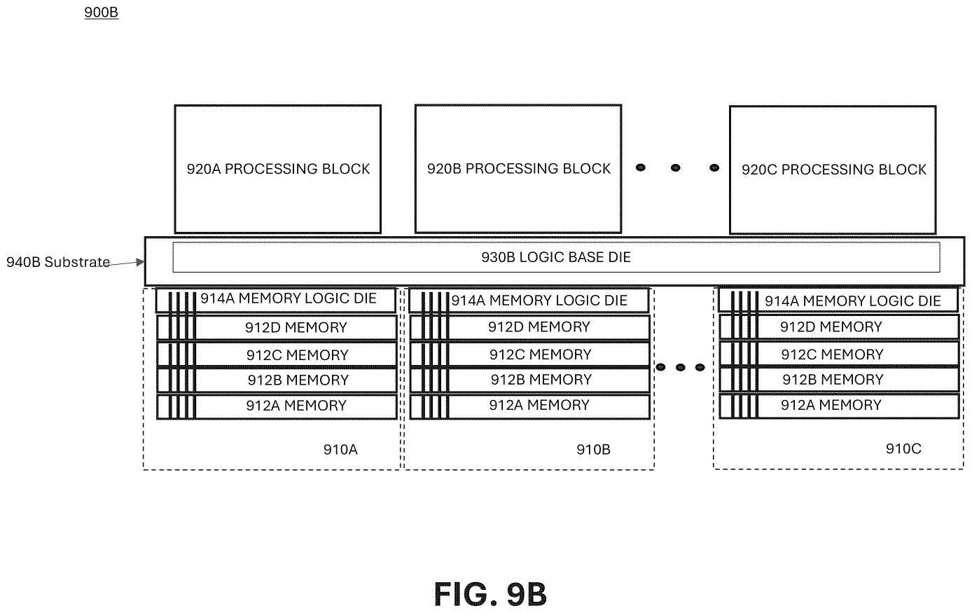

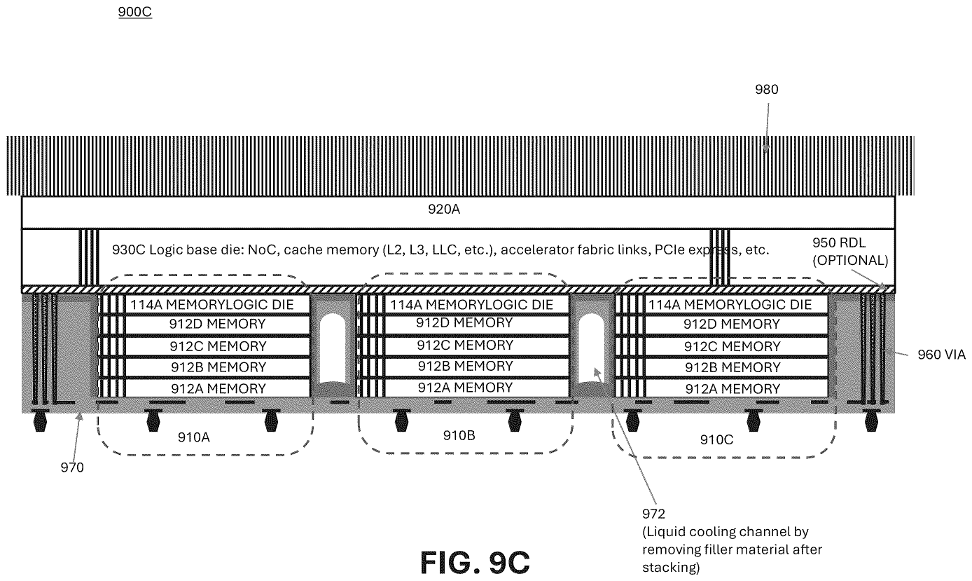

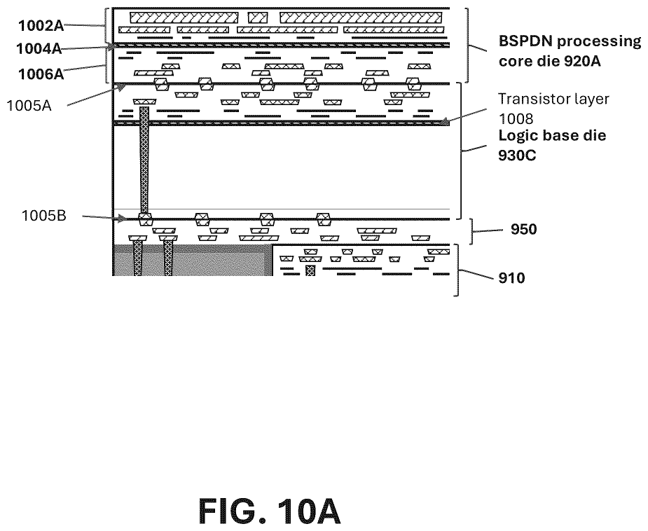

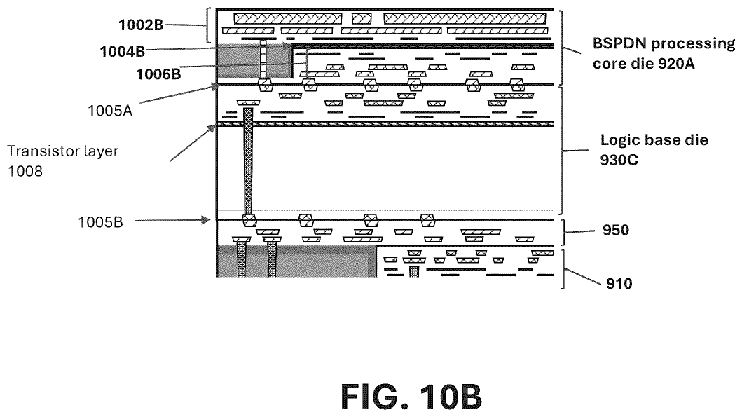

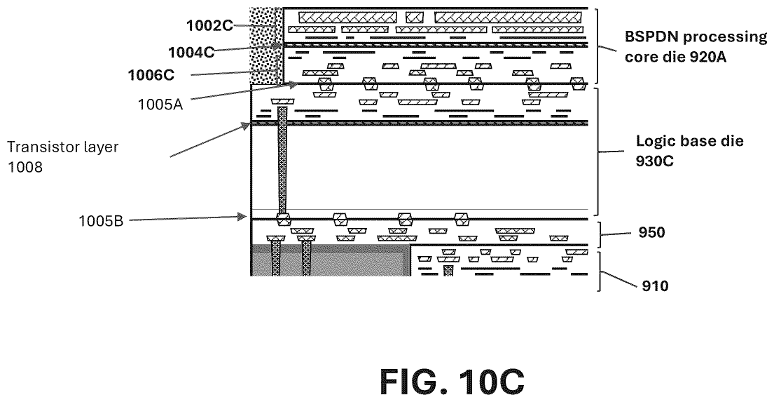

FIGS. 9A-10C illustrate various examples of three-dimensional AI accelerator architectures, according to embodiments disclosed herein. These three-dimensional AI accelerator architectures provide shorter interconnections between processing blocks and memory blocks, leading to efficient power management and lower latency, thereby enhancing the overall performance of the AI accelerators.

FIG. 9A schematically illustrates a diagram of a three-dimensional AI accelerator architecture 900A (hereinafter referred to as “AI accelerator 900A”). As shown in FIG. 9A, the AI accelerator 900A includes a memory block 910, a processing block 920, a substrate 940A, and a logic base die 930A.

The memory block 910 can include a stacked memory (912A-912D) and an optional memory logic die 914A. The stacked memory illustrated in FIG. 9A can include four layers, each of which can be a DRAM. In some embodiments, at least one of the DRAM layers includes circuitry to process data retrieved from its corresponding DRAM, effectively functioning as Processing-In-Memory (PIM). For instance, one or more memory layers in the stacked memory can embed processing cores or circuitry to process data stored within them. Alternatively, at least one memory layer could be a Static Random-Access Memory (SRAM). The stacked memory may include a combination of DRAM, SRAM, and PIM layers. Although FIG. 9A illustrates four layers, this is merely an example; the number of stacked memory layers is not limited and can be 6, 8, 10, 12, 14, 16, 18, 20, or more than 20 layers.

The processing block 920 includes a plurality of parallel processing cores designed to process AI workloads in parallel. These cores can be integrated into one or more computing dies and can include GPUs, NPUs, CPUs or any combination thereof. In some embodiments, the processing block 920 can include multiple computing dies. Each computing die of the processing block 920 can include cache memory, such as Level 1 (L1) cache memory. Furthermore, the processing block can include a processing block base die (e.g., the processing block base die 418 illustrated in FIG. 4) three-dimensionally integrated with the computing die(s) and interposed between the computing die(s) and the substrate 940A. The processing block base die can have circuitry for interconnection with the logic base die 930A, such as circuitry providing die-to-die bonding interfaces, for example USR or UCIe interfaces. In some examples, the processing block base die includes SRAM configured to provide Level 2 (L2) cache memory.

In some embodiments, the processing cores are monolithically fabricated on a single computing die. The number of processing cores can be optimized based on the technology node used in the processing cores. The processing cores and the cache memories (e.g., the L1 cache memory) can be fabricated in a single die (e.g., processing die). In these embodiments, the transistors in the processing cores and those in the cache memories (configuring the SRAMs) can have the same or nearly the same technology node, allowing for efficient integration and manufacturing.

In some embodiments, the substrate 940A illustrated in FIG. 9A may include a single logic base die 930A or include multiple logic base dies 930A. The substrate 940A may also include redistribution layers (RDLs) on either top or bottom side of or on both top and bottom sides of the logic base die(s). In these configurations, the RDLs are configured to redistribute the electrical connections to facilitate high-density interconnects and efficient signal routing between the stacked memory and the logic base die, between the computing dies and the logic base die, and/or between the multiple logic base dies. The RDLs are fabricated using advanced lithography and metallization processes to create fine-pitch interconnects capable of supporting high-bandwidth communication. While not shown, there may be an interposer, e.g., Si interposer, on either side or included as part of the substrate 940A. The logic base die 930A includes interface circuitry, peripheral circuitry, and cache memory. The interface circuitry enables communication between the memory block 910 and the processing block 920, as well as with other memory or processing blocks not shown in FIG. 9A. In some embodiments, the interface circuitry includes a NoC configured to communicatively couple each memory layer of the stacked memory (912A-912D) via TSVs with each computing die in the processing block 920. In some examples, a memory controller is connected to the NoC, and individual memories may not connect directly to the NoC. The NoC serves as a backbone communication path, connecting nodes such as computing die (and the processing cores included in the computing die) and memory layer of the stacked memory. The NoC includes routers and switches that handle data routing between processing cores and memory, facilitating efficient communication. These routers and switches are composed of multiple transistors and can be implemented as monolithically integrated router-based switching networks.

In some embodiments, multiple communication paths can be activated simultaneously, enabling parallel processing by accessing different memory locations concurrently. The NoC can be connected to various data communication standards, such as USR/UCIe interfaces for communication with the processing block 920. It may also be connected to additional interfaces, such as accelerator fabric links for data communication with other AI accelerators or processing cores, as well as PCIe interfaces. Any commercially available communication interfaces used for data communication between semiconductor components of an AI accelerator can be implemented with the NoC without limitation. The NoC can implement various network topologies, such as mesh (with a grid-like arrangement of nodes and routers), torus, ring, or fat tree, depending on specific application requirements. For example, in a mesh topology, processing cores, cache memories, and peripheral circuitry (e.g., memory controllers) are connected to routers as nodes, enabling parallel pathways between nodes to optimize data congestion and latency.

The logic base die 930A may also include peripheral circuitry, such as memory controllers, cache coherence circuitry, and MBIST components. Additional circuitry may include access transistors (used to access specific memory locations during read/write operations), clock signal generators (providing timing signals for synchronization between the memory block and processing block), sense amplifiers (detecting and amplifying voltage differences in memory cells), and more. The logic base die 930A can also include cache memory, such as LLC or Level 3 (L3) cache, providing larger capacity but slower speed compared to L1 or L2 caches. In some cases, the logic base die 930A may include a logic base die processing core that controls and manages the interface logic for the NoC, various other interfaces, and the operation of peripheral circuitry, including cache coherence, memory access, MBIST, and other related functions.

Generally, the memory controller, NoC, and LLC can have a larger technology node (e.g., lower scalability of the technology node/less advanced technology node) than those used in the processing block 920 (processing cores and L1/L2 cache memories). Integrating components, such as the memory controller, NoC, and LLC on the logic base die 930A, separate from the processing block 920, is advantageous for increasing the scalability of the processing cores and enhancing data communication performance (lower latency, higher bandwidth, higher speed) between the memory block 910 and processing block 920 via the NoC.

As further shown in FIG. 9A, the memory block 910 and the processing block 920 are bonded to opposing sides of the substrate 940A. Specifically, the memory block 910 is bonded to the lower side (e.g., first side) of the substrate 940A, while the processing block 920 is bonded to the upper side (e.g., second side) of the substrate 940A. This configuration allows the memory block 910 and the processing block 920 to be directly and three-dimensionally bonded on opposite sides of the substrate 940A, respectively. As illustrated in FIG. 9A, the processing block 920 vertically overlaps with the memory block 910, and the processing block 920 and the memory block 910 can communicate in a vertical direction through the communication interfaces formed in corresponding overlapping regions.

Illustratively, each memory layer of the memory block 910 is connected to the memory controller included in the logic base die 930A through TSVs, where the memory controller is connected with the NoC. The processing block 920 (e.g., computing dies of the processing block 920) can be connected to the NoC of the logic base die 930A by utilizing die-to-die bonding techniques. Thus, the NoC can interconnect (or manage data routing between) the memory layers of the memory block 910 and the computing dies of the processing block 920.

Optionally, the memory block 910 may include a memory logic die 914A, vertically interposed between the stacked memory (912A-912D) and the substrate 940A. In these embodiments, some peripheral circuitry and/or cache memory included in the logic base die 930A can be integrated into the memory logic die 914A. For example, components like the LLC, memory controller (MC), cache coherence circuitry, and MBIST can be integrated into the memory logic die 914A.

By bonding the memory block 910 and processing block 920 on opposite sides of the substrate 940A, the three-dimensional AI accelerator architecture 900A can achieve shorter data path between the processing and memory blocks. This configuration reduces signal propagation delays, lowers latency, and improves power efficiency due to reduced interconnect lengths.

FIG. 9B schematically illustrates a diagram of a three-dimensional AI accelerator architecture 900B (hereinafter referred to as “AI accelerator 900B”). As shown in FIG. 9B, the AI accelerator 900B includes multiple memory blocks 910A-910C, multiple processing blocks 920A-920C, a substrate 940B, and a logic base die 930B.

Each memory block 910A-910C can include a stacked memory (912A-912D) and an optional memory logic die 914A. The stacked memory can include four layers, each of which can be a DRAM. In some embodiments, at least one of the DRAM layers includes circuitry to process data retrieved from its corresponding DRAM, effectively functioning as PIM. For instance, one or more memory layers in the stacked memory can embed processing cores or circuitry to process data stored within them. Alternatively, at least one memory layer could be an SRAM. The stacked memory may include a combination of DRAM, SRAM, and PIM layers. Although FIG. 9B illustrates four layers, this is merely an example; the number of stacked memory layers is not limited and can be 6, 8, 10, 12, 14, 16, 18, 20, or more than 20 layers.

Each processing block of the processing blocks 920A-920C includes a plurality of parallel processing cores designed to process AI workloads in parallel. These cores can be integrated into one or more computing dies and can include GPUs, NPUs, CPUs or any combination thereof. In some embodiments, the processing blocks 920A-920C can include multiple computing dies. Each computing die can include cache memory, such as L1 cache memory. The processing blocks 920A-920C may also include interconnection circuitry to interface with the logic base die 930B. This interconnection circuitry supports die-to-die connections using interfaces such as USR/UCIe without the need for an intervening die. Utilizing USR/UCIe interfaces over traditional PHY layer interfaces (which involve encoding or decoding using PHY) offers advantages in scalability, latency, bandwidth, data rate, and power efficiency.

The substrate 940B illustrated in FIG. 9B, may include a single logic base die 930B or include multiple logic base dies 930B. The substrate 940B may also include redistribution layers (RDLs) on either top or bottom side of or on both top and bottom sides of the logic base die(s). In these configurations, the RDLs are configured to redistribute the electrical connections to facilitate high-density interconnects and efficient signal routing between the stacked memory and the logic base die, between the computing dies and the logic base die, and/or between the multiple logic base dies. The RDLs are fabricated using advanced lithography and metallization processes to create fine-pitch interconnects capable of supporting high-bandwidth communication. While not shown, there may be an interposer, e.g., Si interposer, on either side or included as part of the substrate 940B. The logic base die 930B includes interface circuitry, peripheral circuitry, and cache memory. In some embodiments, the interface circuitry includes an NoC that enables communication between the memory blocks 910A-910C and the processing blocks 920A-920C, as well as between the memory blocks and between the processing blocks themselves. In some embodiments, multiple communication paths can be activated simultaneously, enabling parallel processing by accessing different memory locations concurrently.

The NoC can be connected to various data communication standards, such as accelerator fabric links for data communication with other AI accelerators or processing cores, as well as PCIe interfaces. Any commercially available communication interfaces used for data communication between semiconductor components of an AI accelerator can be implemented in the NoC without limitation. The NOC can implement various network topologies, such as mesh, torus, ring, or fat tree, depending on specific application requirements. For example, in a mesh topology, processing cores, cache memories, and peripheral circuitry (e.g., memory controllers) are connected to routers as nodes, enabling parallel pathways between nodes to optimize data congestion and latency.

In some examples, the logic base die 930B can include memory controllers to access each corresponding memory block. Each memory controller is connected to the NoC without needing individual memories to directly connect to the NoC. Thus, connecting to the NoC enables the processing cores to access the desired memory blocks. For example, the processing block 920A may access one or more memory blocks 910A-910C by connecting to the NoC of the logic base die 930B. Furthermore, multiple processing blocks 920A-920C can access a single memory block via the NoC. In some cases, each processing block can simultaneously access different memory blocks, enabling parallel processing.

The logic base die 930B may also include peripheral circuitry, such as memory controllers, cache coherence circuitry, and MBIST components. Additional circuitry may include access transistors (used to access specific memory locations during read/write operations), clock signal generators (providing timing signals for synchronization between the memory blocks and processing blocks), sense amplifiers (detecting and amplifying voltage differences in memory cells), and more. The logic base die 930B can also include cache memory, such as LLC or L3 cache, providing larger capacity but slower speed compared to L1 or L2 caches. In some cases, the logic base die 930B may include a logic base die processing core that controls and manages the interface logic for the NoC, various other interfaces, and the operation of peripheral circuitry, including cache coherence, memory access, MBIST, and other related functions.

As further shown in FIG. 9B, the memory blocks 910A-910C and the processing blocks 920A-920C are bonded to opposing sides of the substrate 940B. Specifically, the memory blocks 910A-910C are bonded to the lower side (first side) of the substrate 940B, while the processing blocks 920A-920C are bonded to the upper side (second side) of the substrate 940B. This configuration allows the memory blocks and the processing blocks to be directly and three-dimensionally bonded on opposite sides of the substrate 940B, respectively. As illustrated in FIG. 9B, the processing blocks 920A-920C vertically overlaps with the memory blocks 910A-910C, respectively, and these processing blocks and the memory blocks can communicate in a vertical direction through the communication interfaces formed in corresponding overlapping regions.

Optionally, each memory block 910A-910C may include a memory logic die 914A, vertically interposed between the corresponding stacked memory (912A-912D) and the substrate 940B. In these embodiments, some peripheral circuitry and/or cache memory included in the logic base die 930B can be integrated into the corresponding memory logic die 914A. For example, components like the LLC, memory controller (MC), cache coherence circuitry, and MBIST can be integrated into the corresponding memory logic die 914A.

FIG. 9C schematically illustrates a diagram of a three-dimensional AI accelerator architecture 900C (hereinafter referred to as “AI accelerator 900C”). As shown in FIG. 9C, the AI accelerator 900C includes multiple memory blocks 910A-910C, processing cores fabricated with BSPDN 920A (hereinafter referred to as “BSPDN processing core die 920A”), and a logic base die 930C.

In some embodiments, the BSPDN processing core die 920A include BSPDN, as illustrated in FIG. 4. The processing cores are fabricated on a transistor layer, where the interconnect layers on the back-side and front-side of the transistor layer respectively provide mainly power signals and signal routing signals to the BSPDN processing core die. The BSPDN allows for efficient power delivery directly to the transistors from the back side, reducing IR drop and enhancing performance by minimizing power supply noise.

As illustrated in FIG. 9C, the logic base die 930C includes the NoC, cache memory (e.g., L2, L3, and/or LLC), accelerator fabric links, and PCIe interfaces. The functionality and interconnections of these components are described with respect to FIG. 9B (e.g., the logic base die 930B). In some embodiments, these components can have a less advanced technology node than the technology node of the BSPDN processing core die 920A. By integrating these components in the logic base die 930C, separately from the BSPDN processing core die 920A, the architecture allows for increased scalability of the number of processing cores included in the BSPDN processing core die 920A.

As shown in FIG. 9C, the memory blocks 910A-910C are embedded in a substrate 970, which includes a channel 972 (e.g., a hollow portion) between the memory blocks 910A-910C. In some embodiments, a liquid coolant can be flown in this channel 972 to cool the BSPDN processing core die 920A and the memory blocks 910A-910C, thereby enhancing thermal management and preventing overheating.

In some embodiments, the logic base die 930C is interposed between the BSPDN processing core die 920A and the memory blocks 910A-910C. An RDL 950 is interposed between the logic base die 930C and the memory blocks 910A-910C, providing redistribution of electrical connections from the densely packed input/outputs of the memory blocks to align with the interconnect structures of the logic base die 930C. The RDL 950 may also provide interconnections between the memory blocks 910A-910C. The RDL 950 is interconnected to the through-dielectric vias 960, which provide vertical electrical connections through the substrate 970, enabling communication between the logic base die 930C and the input/output interface of the AI accelerator 900C.

To further enhance the cooling of the BSPDN processing core die 920A, a heat dissipation structure 980 is disposed on the top of the BSPDN processing core die 920A, opposite to the logic base die 930C. The heat dissipation structure can include, without limitation, a heat sink, thermal interface material, heat spreader, vapor chamber, heat pipe, or similar components. This structure facilitates efficient heat removal from the processing cores, ensuring optimal operating temperatures and improving the reliability and performance of the AI accelerator 900C.

FIGS. 10A-10C illustrate schematic diagrams of a three-dimensional AI accelerator architecture 900C as depicted in FIG. 9C with various embodiments of the BSPDN processing core die 920A. As shown in FIG. 10A, the logic base die 930C is vertically interposed between the BSPDN processing core die 920A and the memory block 910 (e.g., memory blocks 910A-910C). In some embodiments, the BSPDN processing core die 920A and the logic base die 930C are three-dimensionally bonded at the bonding interface 1005A, while the logic base die 930C and the RDL layer 950 are three-dimensionally bonded at the bonding interface 1005B. The three-dimensional bonding can include hybrid bonding (as illustrated in FIGS. 13A and 13B).

The BSPDN processing core die 920A can include three layers stacked vertically: the BSPDN layer 1002A, the transistor layer 1004A, and the signal interconnection layer 1006A. The BSPDN layer 1002A, positioned at the top (i.e., the backside of the transistor layer 1004A), is utilized for efficiently delivering power to the transistor layer beneath it. This layer contains a multitude of power lines (e.g., VDD and VSS rails) connected directly to the corresponding power terminals of the transistor layer 1004A. By delivering power from the backside, the BSPDN reduces voltage drop (IR drop) and improves power integrity, allowing for higher performance and reduced heat generation. This method separates power delivery from signal routing, minimizing interference and enhancing overall efficiency.

As further illustrated in FIG. 10A, the transistor layer 1004A is positioned between the BSPDN layer 1002A and the signal interconnection layer 1006A. The transistor layer 1004A includes an array of transistors that form one or more processing cores of the AI accelerator. These transistors can be scaled to enable high transistor density and performance. In some cases, cache memory such as L1 cache is also integrated within the transistor layer 1004A, closely coupled with the processing cores to provide rapid access to frequently used data and instructions. The integration of cache memory at this layer reduces latency and improves computational efficiency.

Additionally, the signal interconnection layer 1006A is located beneath the transistor layer 1004A and consists of multiple metal interconnect layers used for signal routing. This layer includes numerous signal paths (e.g., metal wires, vias) that connect the input/output terminals of the transistors in the transistor layer to other components within the processing block or to external interfaces. The signal interconnection layer 1006A is designed to handle high-speed data transmission with minimal signal loss or crosstalk, ensuring efficient communication within the AI accelerator. In the embodiments of FIG. 10A, the BSPDN processing core die 920A is a single GPU die bonded to the logic base die 930C in a die-to-die or wafer-to-wafer bonding process.

In some embodiments, the logic base die 930C includes a transistor layer 1008. This transistor layer 1008 can include circuitry for NoC, cache memory (e.g., L2, L3,and/or LLC), accelerator fabric links, and PCIe interfaces. These circuitries include transistors having a larger scaling factor than the transistors included in the BSPDN processing core die 920A. By integrating these components in the logic base die 930C, separately from the BSPDN processing core die 920A, the architecture allows for increased scalability of the number of processing cores included in the BSPDN processing core die 920A. An RDL 950 can also be interposed between the logic base die 930C and the memory blocks 910A-910C, providing redistribution of electrical connections from the densely packed I/O pads of the memory blocks to align with the interconnect structures of the logic base die 930C.

FIG. 10B illustrates another example of the BSPDN processing core die 920A in the configuration of the three-dimensional AI accelerator 900C shown in FIG. 9C. Similar to previous embodiments.

The BSPDN processing core die 920A includes three layers stacked vertically: the BSPDN layer 1002B, the transistor layer 1004B, and the signal interconnection layer 1006B. The BSPDN layer 1002B, positioned at the top (backside of the transistor layer 1004B), delivers power efficiently to the transistor layer beneath it through numerous power lines (VDD and VSS rails) connected directly to the transistor layer 1004B. This backside power delivery reduces IR drop and enhances power integrity, enabling higher performance and lower heat generation by separating power delivery from signal routing. In the embodiments of FIG. 10B, the BSPDN processing core die 920A includes multiple transistor layers 1004B and multiple associated signal interconnection layers 1006B (only one set is shown in FIG. 10B). Each transistor layer 1004B with its associated signal interconnection layer 1006B can be first fabricated as a chiplet. Multiple chiplets are then bonded to a temporary carrier or directly bonded to a logic base die 930C in a logic base die wafer. After filling the gaps between chiplets with dielectric and a planarization process, the remaining chiplet substrates (on which each transistor layer 1004B is formed) are removed or thinned. The BSPDN layer 1002B is then formed on the backside of the multiple transistor layers 1004B. The BSPDN layer 1002B is mainly for providing power supplies to each transistor layer 1004B. In some embodiments, the BSPDN layer 1002B may provide power or signal interconnections between the multiple transistor layers 1004B. In other embodiments, the BSPDN layer 1002B may have direct contacts to the logic base die 930C using through-dielectric vias beside the chiplets.

As illustrated, the transistor layer 1004B is situated between the BSPDN layer 1002B and the signal interconnection layer 1006B. It contains an array of transistors forming one or more processing cores of the AI accelerator. Scaling these transistors allows for high density and performance. Integration of cache memory such as L1 cache within the transistor layer 1004B provides rapid access to frequently used data, reducing latency and improving computational efficiency.

The signal interconnection layer 1006B, located beneath the transistor layer 1004B, can include multiple metal interconnect layers for signal routing. It includes numerous signal paths connecting the I/O terminals of the transistors to other components or external interfaces. Designed for high-speed data transmission with minimal signal loss or crosstalk, this layer ensures efficient communication within the AI accelerator.

The logic base die 930C includes a transistor layer 1008 containing circuitry for NoC, cache memory (e.g., L2, L3, LLC), accelerator fabric links, and PCIe interfaces. These components utilize transistors with a larger scaling factor than those in the BSPDN processing core die 920A, facilitating increased scalability of processing cores. The RDL 950 interposed between the logic base die 930C and the memory blocks 910A-910C aligns electrical connections from the memory blocks to the logic base die.

FIG. 10C presents yet another example of the BSPDN processing core die 920A in the configuration of the three-dimensional AI accelerator architecture 900C. In the embodiments of FIG. 10C, the BSPDN processing core die 920A include multiple chiplets (only one chiplet is shown in FIG. 10C). Each chiplet can include three layers stacked vertically: the BSPDN layer 1002C, the transistor layer 1004C, and the signal interconnection layer 1006C. The BSPDN layer 1002C, located at the top, efficiently delivers power to the transistor layer 1004C beneath it via power lines (VDD and VSS rails). Backside power delivery reduces IR drop and enhances power integrity, leading to higher performance and reduced heat generation by isolating power delivery from signal routing. The gaps between the chiplets are filled with dielectric followed by a planarization process.

The transistor layer 1004C, positioned between the BSPDN layer 1002C and the signal interconnection layer 1006C, contains transistors forming the processing cores of the AI accelerator. High transistor density and performance are achieved through scaling. Cache memory, such as L1 cache, may be integrated within the transistor layer 1004C, closely coupled with the processing cores to provide rapid access to frequently used data, thereby reducing latency.

The signal interconnection layer 1006C, beneath the transistor layer 1004C, includes multiple metal interconnect layers for signal routing. It can include numerous signal paths connecting the transistors' I/O terminals to other components within the processing block or to external interfaces. This layer is optimized for high-speed data transmission with minimal signal loss or crosstalk, ensuring efficient communication.

The logic base die 930C features a transistor layer 1008 with circuitry for NoC, cache memory (L2, L3, LLC), accelerator fabric links, and PCIe interfaces. These circuitries employ transistors with a larger scaling factor than those in the BSPDN processing core die 920A, allowing for increased scalability of the processing cores. An RDL 950 is interposed between the logic base die 930C and the memory blocks 910A-910C, facilitating the redistribution of electrical connections from the densely packed I/O pads of the memory blocks to align with the interconnect structures of the logic base die 930C.

### Example of Three Dimensional AI Accelerator Architecture

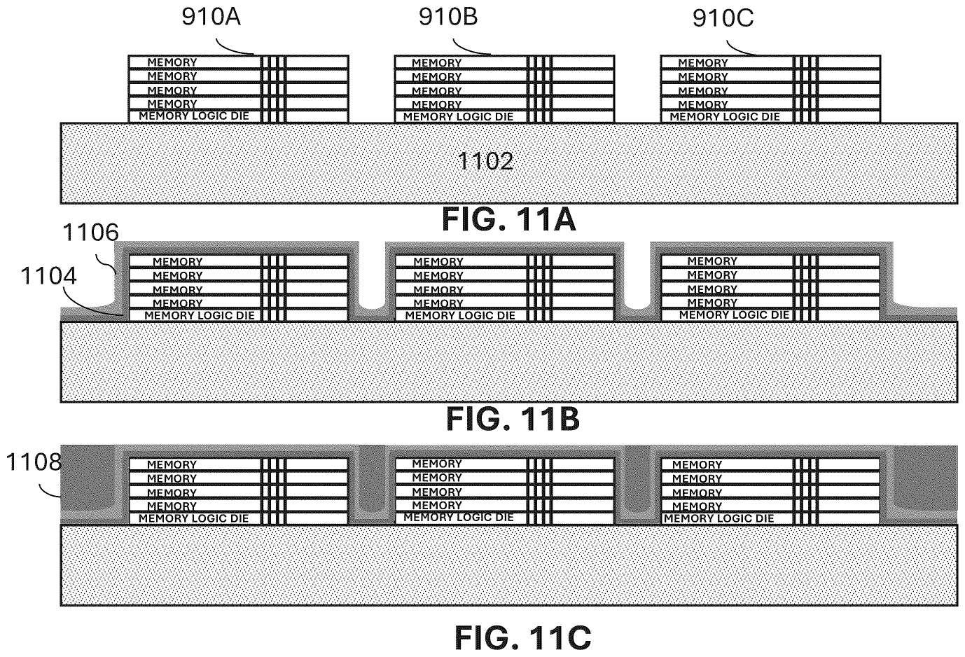

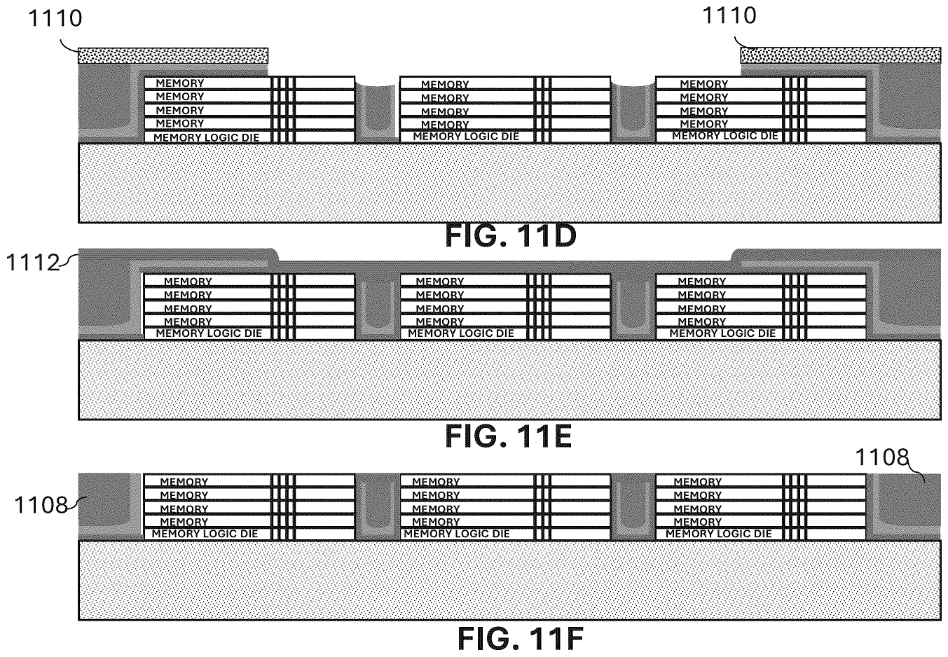

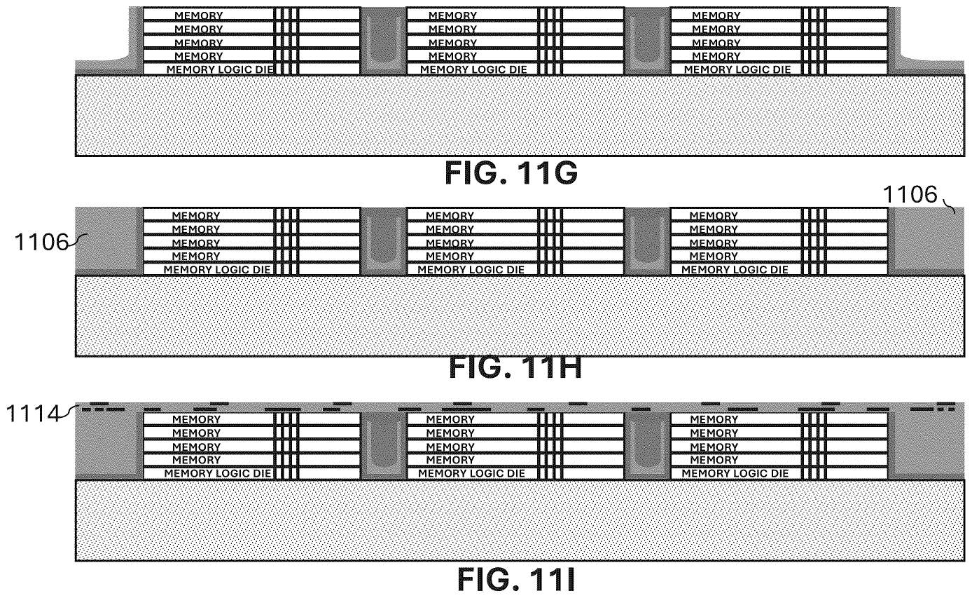

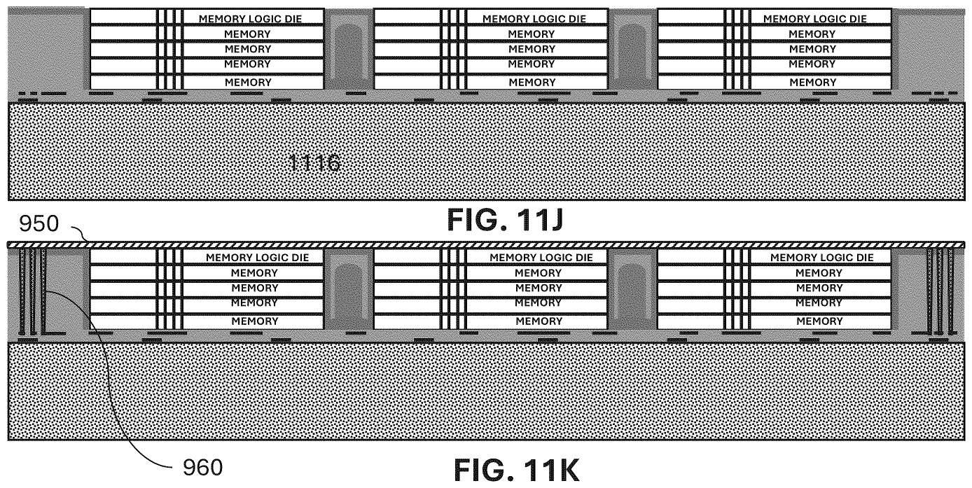

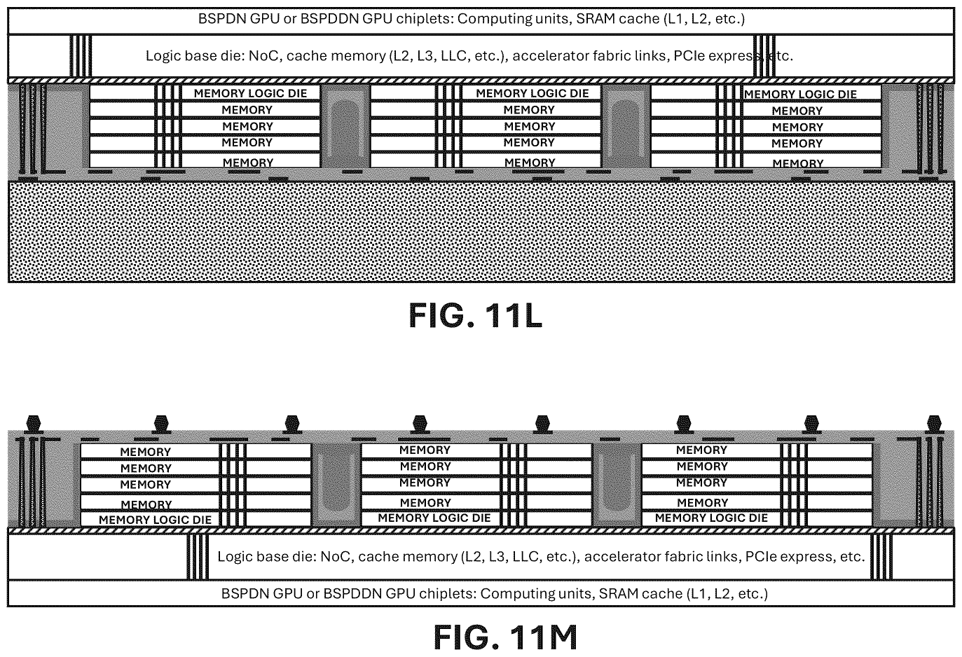

FIGS. 11A-11M illustrate a method of manufacturing the AI accelerator 900C, according to embodiments disclosed herein.

First, as illustrated in FIG. 11A, three stacked memory blocks 910A-910C are vertically disposed on a temporary carrier 1102. Each memory block can comprise multiple layers of memory cells, such as DRAM, SRAM, or PIM layers, as previously described.

Second, as illustrated in FIG. 11B, a first thin layer 1104 is applied on the top surface of the structure, covering the memory blocks 910A-910C and the exposed portions of the temporary carrier 1102. Subsequently, a second thin layer 1106 is applied on top of the first thin layer 1104. The first thin layer 1104 and the second thin layer 1106 are formed of different materials that selected to provide functional and/or processing advantages. The first and second thin layers 1104, 1106 can be different ones of a metal oxide (including silicon oxide), a metal nitride (including metal nitride), polysilicon or a combination thereof. The different materials can be selected to provide synergistic advantages including diffusion barrier characteristics, passivation characteristic and etch selectivity, to name a few.

Third, as illustrated in FIG. 11C, a filling material 1108 is deposited between and over the memory blocks 910A-910C, followed by a planarization process to expose the silicon oxide 1106 on top of the memory blocks. The filling material 1108 can include silicon-organic compound materials, such as spin-on dielectrics or other suitable insulating materials.

Fourth, as illustrated in FIG. 11D, a masking layer 1110 is applied to selectively etch portions of the silicon oxide layer 1106 and nitride liner 1104. The masking layer 1110 is patterned to cover areas where channels (e.g., channels 972 shown in FIG. 9C) are not intended to be formed, leaving exposed areas where channels are desired, specifically between memory blocks 910A and 910B, and between 910B and 910C. In the exposed areas, the nitride liner 1104, silicon oxide 1106, and the filling material 1108 between the adjacent memory blocks are slightly recessed with respect to the top surface of the memory blocks.

Fifth, as illustrated in FIG. 11E, the masking layer 1110 is removed from the top surface. Another layer of nitride liner 1112 is deposited over the memory blocks 910A-910C and fills the recesses between the adjacent memory blocks.

Sixth, as illustrated in FIG. 11F, a planarization process removes dielectrics on top of the memory blocks 910A-910C, leaving remaining portion of the nitride liner 1112 in the recesses between the adjacent memory blocks as nitride caps. In the areas where liquid cooling channels (e.g., channels 972 shown in FIG. 9C) are not intended to be formed, the filling material 1108 is exposed.

Seventh, as illustrated in FIG. 11G, the filling material 1108 is selectively removed from the exposed areas, creating open spaces adjacent to the memory blocks 910A-910C.

Eighth, as illustrated in FIG. 11H, the open spaces are filled with another silicon oxide 1106, followed by a planarization process.

Ninth, as illustrated in FIG. 11I, an RDL layer 1114 is formed on top of the memory blocks 910A-910C. The RDL 1114 redistributes the electrical connections from the memory blocks to align with subsequent interconnect structures, including the input/output interface of the AI accelerator 900C. The RDL can be formed using photolithography and metallization processes to create the desired routing patterns. In some embodiments, the RDL layer 1114 may include bump pads for a later solder bumping or copper pillar bumping process.

Tenth, as illustrated in FIG. 11J, the RDL 1114 side of the entire structure from FIG. 11I is bonded to another temporary carrier 1116. The temporary carrier 1102 is then removed, for example, by grinding or etching processes, exposing the underside of the memory blocks 910A-910C.

Eleventh, as illustrated in FIG. 11K, the through-dielectric vias 960 are formed beside the memory blocks 910A-910C followed by the formation of the RDL 950 over the memory blocks. This RDL 950 provides further redistribution of electrical connections and interfaces with other components, such as the logic base die 930C. The through-dielectric vias 960 provides vertical electrical connections between the RDL 950 and the RDL 1114, enabling communication between the logic base die 930C and the input/output interface of the AI accelerator 900C.

Twelfth, as illustrated in FIG. 11L, the logic base die 930C and the BSPDN processing core dies 920A are bonded to the structure. This bonding can be achieved using three-dimensional bonding techniques, such as hybrid bonding (as illustrated in FIGS. 13A and 13B), at bonding interfaces similar to those shown in FIGS. 10A-10C. The logic base die 930C is interposed between the BSPDN processing core dies 920A and the memory blocks 910A-910C, facilitating communication and power distribution between them.

Thirteenth, as illustrated in FIG. 11M, the carrier wafer 1116 is removed, completing the assembly of the AI accelerator 900C with the formation of solder bumps or copper pillars on the RDL layer 1114. The final structure includes the memory blocks 910A-910C, the logic base die 930C, and the BSPDN processing core dies 920A, integrated in a three-dimensional configuration that optimizes performance and scalability. The remaining filling material 1108 between the memory blocks will be selectively removed in a later assembly process, providing liquid cooling channels 972 as shown in FIG. 9C. A liquid coolant can be flown in this channel 972 to cool the BSPDN processing core die 920A and the memory blocks 910A-910C, thereby enhancing thermal management and preventing overheating.

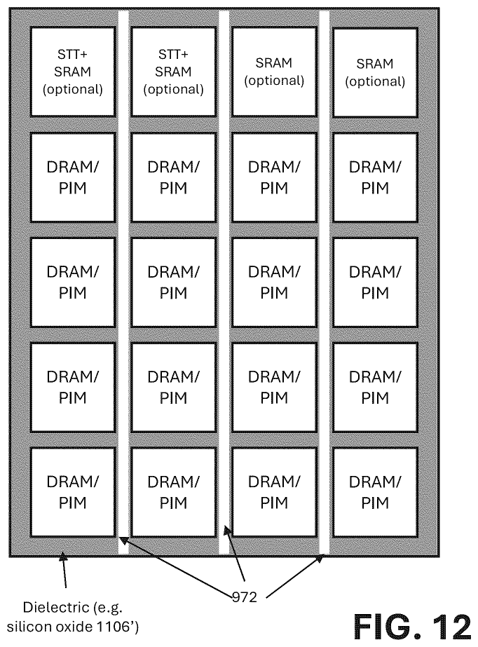

FIG. 12 illustrates an example of an array of memory blocks (e.g., implemented in the process of FIGS. 11A-11M) with micro fluid channels 972. As illustrated in FIG. 12, the micro channels are formed between columns of the memory blocks.

### 3D Bonding Structure

The 3D bonding(e.g., 3D stacking) disclosed herein relates to directly bonded structures in which two or more elements can be directly bonded to one another without an intervening adhesive. Such processes and structures can also be referred to herein as “direct bonding” processes or “directly bonded” structures. Direct bonding can involve bonding of one material on one element and one material on the other element (also referred to as “uniform” direct bond herein), where the materials on the different elements need not be the same, without traditional adhesive materials. Direct bonding can also involve the bonding of multiple materials on one element to multiple materials on the other element (e.g., hybrid bonding).

In some implementations (not illustrated), each bonding layer has one material. In these uniform direct bonding processes, only one material on each element is directly bonded. Example uniform direct bonding processes include the ZIBOND® techniques commercially available from Adeia of San Jose, CA. The materials of opposing bonding layers on the different elements can be the same or different, and may comprise elemental or compound materials. For example, in some embodiments, nonconductive bonding layers can be blanket deposited over the base substrate portions without being patterned with conductive features (e.g., without pads). In other embodiments, the bonding layers can be patterned on one or both elements, and can be the same or different from one another, but one material from each element is directly bonded without adhesive across surfaces of the elements (or across the surface of the smaller element if the elements are differently-sized). In another implementation of uniform direct bonding, one or both of the nonconductive bonding layers may include one or more conductive features, but the conductive features are not involved in the bonding. For example, in some implementations, opposing nonconductive bonding layers can be uniformly directly bonded to one another, and through substrate vias (TSVs) can be subsequently formed through one element after bonding to provide electrical communication to the other element.

In various embodiments, the bonding layers 1308A and/or 1308B can comprise a non-conductive material such as a dielectric material or an undoped semiconductor material, such as undoped silicon, which may include native oxide. Suitable dielectric bonding surface or materials for direct bonding include but are not limited to inorganic dielectrics, such as silicon oxide, silicon nitride, or silicon oxynitride, or can include carbon, such as silicon carbide, silicon ox carbonitride, low K dielectric materials, SiCOH dielectrics, silicon carbonitride or diamond-like carbon or a material comprising a diamond surface. Such carbon-containing ceramic materials can be considered inorganic, despite the inclusion of carbon. In some embodiments, the dielectric materials at the bonding surface do not comprise polymer materials, such as epoxy (e.g., epoxy adhesives, cured epoxies, or epoxy composites such as FR-4 materials), resin or molding materials.

In other embodiments, the bonding layers can comprise an electrically conductive material, such as a deposited conductive oxide material, e.g., indium tin oxide (ITO), as disclosed in U.S. Provisional Patent Application No. 63/524,564, filed Jun. 30, 2023, the entire contents of which is incorporated by reference herein in its entirety for providing examples of conductive bonding layers without shorting contacts through the interface.

In direct bonding, first and second elements can be directly bonded to one another without an adhesive, which is different from a deposition process and results in a structurally different interface compared to that produced by deposition. In one application, a width of the first element in the bonded structure is similar to a width of the second element. In some other embodiments, a width of the first element in the bonded structure is different from a width of the second element. The width or area of the larger element in the bonded structure may be at least 10% larger than the width or area of the smaller element. Further, the interface between directly bonded structures, unlike the interface beneath deposited layers, can include a defect region in which nanometer-scale voids (nanovoids) are present. The nanovoids may be formed due to activation of one or both of the bonding surfaces (e.g., exposure to a plasma, explained below).

The bond interface between non-conductive bonding surfaces can include a higher concentration of materials from the activation and/or last chemical treatment processes compared to the bulk of the bonding layers. For example, in embodiments that utilize a nitrogen plasma for activation, a nitrogen concentration peak can be formed at the bond interface. In some embodiments, the nitrogen concentration peak may be detectable using logic base die ion mass spectroscopy (SIMS) techniques. In various embodiments, for example, a nitrogen termination treatment (e.g., exposing the bonding surface to a nitrogen-containing plasma) can replace OH groups of a hydrolyzed (OH-terminated) surface with NH₂ molecules, yielding a nitrogen-terminated surface. In embodiments that utilize an oxygen plasma for activation, an oxygen concentration peak can be formed at the bond interface between non-conductive bonding surfaces. In some embodiments, the bond interface can comprise silicon oxynitride, silicon oxycarbonitride, or silicon carbonitride. The direct bond can comprise a covalent bond, which is stronger than van Der Waals bonds. The bonding layers can also comprise polished surfaces that are planarized to a high degree of smoothness.

In direct bonding processes, such as uniform direct bonding and hybrid bonding, two elements are bonded together without an intervening adhesive. In non-direct bonding processes that utilize an adhesive, an intervening material is typically applied to one or both elements to effectuate a physical connection between the elements. For example, in some adhesive-based processes, a flowable adhesive (e.g., an organic adhesive, such as an epoxy), which can include conductive filler materials, can be applied to one or both elements and cured to form the physical (rather than chemical or covalent) connection between elements. Many organic adhesives lack strong chemical or covalent bonds with either element. In such processes, the connections between the elements are weak and/or readily reversed, such as by reheating.

By contrast, direct bonding processes join two elements by forming strong chemical bonds (e.g., covalent bonds) between opposing nonconductive materials. For example, in direct bonding processes between nonconductive materials, one or both nonconductive surfaces of the two elements are planarized and chemically prepared (e.g., activated and/or terminated) such that when the elements are brought into contact, strong chemical bonds (e.g., covalent bonds) are formed, which are stronger than Van der Waals or hydrogen bonds. In some implementations (e.g., between opposing dielectric surfaces, such as opposing silicon oxide surfaces), the chemical bonds can occur spontaneously at room temperature upon being brought into contact. In some implementations, the chemical bonds between opposing non-conductive materials can be strengthened after annealing the elements.

As noted above, hybrid bonding is a species of direct bonding in which both non-conductive features directly bond to non-conductive features, and conductive features directly bond to conductive features of the elements being bonded. The non-conductive bonding materials and interface can be as described above, while the conductive bond can be formed, for example, as a direct metal-to-metal connection. In one example conventional metal bonding process, a fusible metal alloy (e.g., solder) can be provided between the conductors of two elements, heated to melt the alloy, and cooled to form the connection between the two elements. The resulting bond often evinces sharp interfaces with conductors from both elements, and is subject to reversal by reheating. By way of contrast, direct metal bonding as employed in hybrid bonding does not require melting or an intermediate fusible metal alloy, and can result in strong mechanical and electrical connections, often demonstrating interdiffusion of the bonded conductive features with grain growth across the bonding interface between the elements, even without the much higher temperatures and pressures of thermocompression bonding.

FIGS. 13A and 13B schematically illustrate cross-sectional side views of first and second elements 1302, 1304 prior to and after, respectively, a process for forming a 3D stacking (e.g., 3D bonding) structure, and more particularly a hybrid bonded structure, according to some embodiments. In FIG. 13B, a bonded structure 1300 comprises the first and second elements 1302 and 1304 that are directly bonded to one another at a bond interface 1318 without an intervening adhesive. Conductive features 1306A of a first element 1302 may be electrically connected to corresponding conductive features 1306B of a second element 1304. In the illustrated hybrid bonded structure 1300, the conductive features 1306A are directly bonded to the corresponding conductive features 1306B without intervening solder or conductive adhesive.

The conductive features 1306A and 1306B of the illustrated embodiment are embedded in, and can be considered part of, a first bonding layer 1308A of the first element 1302 and a second bonding layer 1308B of the second element 1304, respectively. Field regions of the bonding layers 1308A, 1308B extend between and partially or fully surround the conductive features 1306A, 1306B. The bonding layers 1308A, 1308B can comprise layers of non-conductive materials suitable for direct bonding, as described above, and the field regions are directly bonded to one another without an adhesive. The non-conductive bonding layers 1308A, 1308B can be disposed on respective front sides 1314A, 1314B of base substrate portions 1310A, 1310B.

The first and second elements 1302, 1304 can comprise microelectronic elements, such as semiconductor elements, including, for example, integrated device dies, wafers, passive devices, discrete active devices such as power switches, MEMS, etc. In some embodiments, the base substrate portion can comprise a device portion, such as a bulk semiconductor (e.g., silicon) portion of the elements 1302, 1304, and back-end-of-line (BEOL) interconnect layers over such semiconductor portions. The bonding layers 1308A, 1308B can be provided as part of such BEOL layers during device fabrication, as part of redistribution layers (RDL), or as specific bonding layers added to existing devices, with bond pads extending from underlying contacts. Active devices and/or circuitry (not shown) can be patterned and/or otherwise disposed in or on the base substrate portions 1310A, 1310B, and can electrically communicate with at least some of the conductive features 1306A, 1306B. Active devices and/or circuitry can be disposed at or near the front sides 1314A, 1314B of the base substrate portions 1310A, 1310B, and/or at or near opposite backsides 1316A, 1316B of the base substrate portions 1310A, 1310B. In other embodiments, one or both of the 1302, 1304 may not include active circuitry, but may instead comprise dummy elements, passive interposers, passive optical elements (e.g., glass substrates, gratings, lenses), etc. The bonding layers 1308A, 1308B are shown as being provided on the front sides of the elements, but similar bonding layers can be additionally or alternatively provided on the back sides of the elements.

In some embodiments, the base substrate portions 1310A, 1310B can have significantly different coefficients of thermal expansion (CTEs), and bonding elements that include such different based substrate portions can form a heterogenous bonded structure. The CTE difference between the base substrate portions 1310A and 1310B, and particularly between bulk semiconductor (typically single crystal) portions of the base substrate portions 1310A, 1310B, can be greater than 5 ppm/°C. or greater than 10 ppm/°C. For example, the CTE difference between the base substrate portions 1310A and 1310B can be in a range of 5 ppm/°C.. to 100 ppm/°C., 5 ppm/°C. to 40 ppm/°C., 10 ppm/°C. to 100 ppm/C., or 10 ppm/°C. to 40 ppm/°C.

In some embodiments, one of the base substrate portions 1310A, 1310B can comprise optoelectronic single crystal materials, including perovskite materials, which are useful for optical piezoelectric or pyroelectric applications, and the other of the base substrate portions 1310A, 1310B comprises a more conventional substrate material. For example, one of the base substrate portions 1310A, 1310B comprises lithium tantalate (LiTaO3) or lithium niobate (LiNbO3), and the other one of the base substrate portions 1310A, 1310B comprises silicon (Si), quartz, fused silica glass, sapphire, or a glass. In other embodiments, one of the base substrate portions 1310A, 1310B comprises a III-V single semiconductor material, such as gallium arsenide (GaAs) or gallium nitride (GaN), and the other one of the base substrate portions 1310A, 1310B can comprise a non-III-V semiconductor material, such as silicon (Si), or can comprise other materials with similar CTE, such as quartz, fused silica glass, sapphire, or a glass. In still other embodiments, one of the base substrate portions 1310A, 1310B comprises a semiconductor material and the other of the base substrate portions 1310A, 1310B comprises other materials, such as a glass, organic or ceramic substrate.

In some arrangements, the first element 1302 can comprise a singulated element, such as a singulated integrated device die. In other arrangements, the first element 1302 can comprise a carrier or substrate (e.g., a semiconductor wafer) that includes a plurality (e.g., tens, hundreds, or more) of device regions that, when singulated, forms a plurality of integrated device dies, though in other embodiments such a carrier can be a package substrate (e.g., a laminate substrate, a ceramic substrate, etc.) or a passive or active interposer. Similarly, the second element 1304 can comprise a singulated element, such as a singulated integrated device die. In other arrangements, the second element 1304 can comprise a carrier or substrate (e.g., a semiconductor wafer). The embodiments disclosed herein can accordingly apply to wafer-to-wafer (W2W), die-to-die (D2D), or die-to-wafer (D2W) bonding processes. In W2W processes, two or more wafers can be directly bonded to one another (e.g., direct hybrid bonded) and singulated using a suitable singulation process. After singulation, side edges of the singulated structure (e.g., the side edges of the two bonded elements) can be substantially flush (substantially aligned x-y dimensions) and/or the edges of the bonding layers for both bonded and singulated elements can be coextensive, and may include markings indicative of the common singulation process for the bonded structure (e.g., saw markings if a saw singulation process is used).

While only two elements 1302, 1304 are shown, any suitable number of elements can be stacked in the bonded structure 1300. For example, a third element (not shown) can be stacked on the second element 1304, a fourth element (not shown) can be stacked on the third element, and so forth. In such implementations, through substrate vias (TSVs) can be formed to provide vertical electrical communication between and/or among the vertically-stacked elements. Additionally or alternatively, one or more additional elements (not shown) can be stacked laterally adjacent one another along the first element 1302. In some embodiments, a laterally stacked additional element may be smaller than the second element. In some embodiments, the bonded structure can be encapsulated with an insulating material, such as an inorganic dielectric (e.g., silicon oxide, silicon nitride, silicon oxynitrocarbide, etc.). One or more insulating layers can be provided over the bonded structure. For example, in some implementations, a first insulating layer can be conformally deposited over the bonded structure, and a second insulating layer (which may include be the same material as the first insulating layer, or a different material) can be provided over the first insulating layer.

To effectuate direct bonding between the bonding layers 1308A, 1308B, the bonding layers 1308A, 1308B can be prepared for direct bonding. Non-conductive bonding surfaces 1312A, 1312B at the upper or exterior surfaces of the bonding layers 1308A, 1308B can be prepared for direct bonding by polishing, for example, by chemical mechanical polishing (CMP). The roughness of the polished bonding surfaces 1312A, 1312B can be less than 30 Å rms. For example, the roughness of the bonding surfaces 1312A and 1312B can be in a range of about 0.1 Å rms to 15 Å rms, 0.5 Å rms to 10 Å rms, or 1 Å rms to 5 Å rms. Polishing can also be tuned to leave the conductive features 1306A, 1306B recessed relative to the field regions of the bonding surfaces 1312A, 1312B.

Preparation for direct bonding can also include cleaning and exposing one or both of the bonding surfaces 1312A, 1312B to a plasma and/or etchants to activate at least one of the surfaces 1312A, 1312B. In some embodiments, one or both of the surfaces 1312A, 1312B can be terminated with a species after activation or during activation (e.g., during the plasma and/or etch processes). Without being limited by theory, in some embodiments, the activation process can be performed to break chemical bonds at the bonding surface(s) 1312A, 1312B, and the termination process can provide additional chemical species at the bonding surface(s) 1312A, 1312B that alters the chemical bond and/or improves the bonding energy during direct bonding. In some embodiments, the activation and termination are provided in the same step, e.g., a plasma to activate and terminate the surface(s) 1312A, 1312B. In other embodiments, one or both of the bonding surfaces 1312A, 1312B can be terminated in a separate treatment to provide the additional species for direct bonding. In various embodiments, the terminating species can comprise nitrogen. For example, in some embodiments, the bonding surface(s) 1312A, 1312B can be exposed to a nitrogen-containing plasma. Other terminating species can be suitable for improving bonding energy, depending upon the materials of the bonding surfaces 1312A, 1312B. Further, in some embodiments, the bonding surface(s) 1312A, 1312B can be exposed to fluorine. For example, there may be one or multiple fluorine concentration peaks at or near a bond interface 1318 between the first and second elements 1302, 1304. Typically, fluorine concentration peaks occur at interfaces between material layers. Additional examples of activation and/or termination treatments may be found in U.S. Pat. No. 9,391,143 at Col. 5, line 55 to Col. 7, line 3; Col. 8, line 52 to Col. 9, line 45; Col. 10, lines 24-36; Col. 11, lines 24-32, 42-47, 52-55, and 60-64; Col. 12, lines 3-14, 31-33, and 55-67; Col. 14, lines 38-40 and 44-50; and 10,434,749 at Col. 4, lines 41-50; Col. 5, lines 7-22, 39, 55-61; Col. 8, lines 25-31, 35-40, and 49-56; and Col. 12, lines 46-61, the activation and termination teachings of which are incorporated by reference herein.

Thus, in the directly bonded structure 1300, the bond interface 1318 between two non-conductive materials (e.g., the bonding layers 1308A, 1308B) can comprise a smooth interface with higher nitrogen (or other terminating species) content and/or fluorine concentration peaks at the bond interface 1318. In some embodiments, the nitrogen and/or fluorine concentration peaks may be detected using various types of inspection techniques, such as SIMS techniques. The polished bonding surfaces 1312A and 1312B can be slightly rougher (e.g., about 1 Å rms to 30 Å rms, 3 Å rms to 20 Å rms, or possibly rougher) after an activation process. In some embodiments, activation and/or termination can result in slightly smoother surfaces prior to bonding, such as where a plasma treatment preferentially smooths out high points on the bonding surface.

The non-conductive bonding layers 1308A and 1308B can be directly bonded to one another without an adhesive. In some embodiments, the elements 1302, 1304 are brought together at room temperature, without the need for application of a voltage, and without the need for application of external pressure or force beyond that used to initiate contact between the two elements 1302, 1304. Contact alone can cause direct bonding between the non-conductive surfaces of the bonding layers 1308A, 1308B (e.g., covalent dielectric bonding). Subsequent annealing of the bonded structure 1300 can cause the conductive features 1306A, 1306B to directly bond.

In some embodiments, prior to direct bonding, the conductive features 1306A, 1306B are recessed relative to the surrounding bonding surfaces, such that a total gap between opposing contacts after dielectric bonding and prior to anneal is less than 15 nm, or less than 10 nm. Because the recess depths for the conductive features 1306A and 1306B can vary across each element, due to process variation, the noted gap can represent a maximum or an average gap between corresponding conductive features 1306A, 1306B of two joined elements (prior to anneal). Upon annealing, the conductive features 1306A and 1306B can expand and contact one another to form a metal-to-metal direct bond.

During annealing, the conductive features 1306A, 1306B (e.g., metallic material) can expand while the direct bonds between surrounding non-conductive materials of the bonding layers 1308A, 1308B resist separation of the elements, such that the thermal expansion increases the internal contact pressure between the opposing conductive features. Annealing can also cause metallic grain growth across the bonding interface, such that grains from one element migrate across the bonding interface at least partially into the other element, and vice versa. Thus, in some hybrid bonding embodiments, opposing conductive materials are joined without heating above the conductive materials' melting temperature. In various embodiments, bonds can form at lower temperatures compared to soldering or thermocompression bonding.

In various embodiments, the conductive features 1306A, 1306B can comprise discrete pads, contacts, electrodes, or traces at least partially embedded in the non-conductive field regions of the bonding layers 1308A, 1308B. In some embodiments, the conductive features 1306A, 1306B can comprise exposed contact surfaces of TSVs (e.g., through silicon vias).

As noted above, in some embodiments, in the elements 1302, 1304 of FIG. 7A prior to direct bonding, portions of the respective conductive features 1306A and 1306B can be recessed below the non-conductive bonding surfaces 1312A and 1312B, for example, recessed by less than 30 nm, less than 20 nm, less than 15 nm, or less than 10 nm, for example, recessed in a range of 2 nm to 20 nm, or in a range of 4 nm to 10 nm. Due to process variation, both dielectric thickness and conductor recess depths can vary across an element. Accordingly, the above recess depth ranges may apply to individual conductive features 1306A, 1306B or to average depths of the recesses relative to local non-conductive field regions. Even for an individual conductive feature 1306A, 1306B, the vertical recess can vary across the surface of the feature, and can be measured at or near the lateral middle or center of the cavity in which a given conductive feature 1306A, 1306B is formed, or can be measured at the sides of the cavity.

Beneficially, the use of hybrid bonding techniques (such as Direct Bond Interconnect, or DBI®, techniques commercially available from Adeia of San Jose, CA) can enable high density of connections between conductive features 1306A, 1306B across the direct bond interface 1318 (e.g., small or fine pitches for regular arrays).

In some embodiments, a pitch p of the conductive features 1306A, 1306B, such as conductive traces embedded in the bonding surface of one of the bonded elements, may be less than 40 μm, less than 20 μm, less than 10 μm, less than 5 μm, less than 2 μm, or even less than 1 μm. For some applications, the ratio of the pitch of the conductive features 1306A and 1306B to one of the lateral dimensions (e.g., a diameter) of the conductive feature is less than is less than 20, or less than 10, or less than 5, or less than 3 and sometimes desirably less than 2. In various embodiments, the conductive features 1306A and 1306B and/or traces can comprise copper or copper alloys, although other metals may be suitable, such as nickel, aluminum, or alloys thereof. The conductive features disclosed herein, such as the conductive features 1306A and 1306B, can comprise fine-grain metal (e.g., a fine-grain copper). Further, a major lateral dimension (e.g., a pad diameter) can be small as well, e.g., in a range of about 0.25 μm to 30 μm, in a range of about 0.25 μm to 5 μm, or in a range of about 0.5 μm to 5 μm.

For hybrid bonded elements 1302, 1304, as shown, the orientations of one or more conductive features 1306A, 1306B from opposite elements can be opposite to one another. As is known in the art, conductive features in general can be formed with close to vertical sidewalls, particularly where directional reactive ion etching (RIE) defines the conductor sidewalls either directly though etching the conductive material or indirectly through etching surrounding insulators in damascene processes. However, some slight taper to the conductor sidewalls can be present, wherein the conductor becomes narrower and farther away from the surface initially exposed to the etch. The taper can be even more pronounced when the conductive sidewall is defined directly or indirectly with isotropic wet or dry etching. In the illustrated embodiment, at least one conductive feature 1306B in the bonding layer 1308B (and/or at least one internal conductive feature, such as a BEOL feature) of the upper element 1304 may be tapered or narrowed upwardly, away from the bonding surface 1312B. By way of contrast, at least one conductive feature 1306A in the bonding layer 1308A (and/or at least one internal conductive feature, such as a BEOL feature) of the lower element 1302 may be tapered or narrowed downwardly, away from the bonding surface 1312A. Similarly, any bonding layers (not shown) on the backsides 1316A, 1316B of the elements 1302, 1304 may taper or narrow away from the backsides, with an opposite taper orientation relative to front side conductive features 1306A, 1306B of the same element.

As described above, in an anneal phase of hybrid bonding, the conductive features 1306A, 1306B can expand and contact one another to form a metal-to-metal direct bond. In some embodiments, the materials of the conductive features 1306A, 1306B of opposite elements 1302, 1304 can interdiffuse during the annealing process. In some embodiments, metal grains grow into each other across the bond interface 1318. In some embodiments, the metal is or includes copper, which can have grains oriented along the 111 crystal plane for improved copper diffusion across the bond interface 1318. In some embodiments, the conductive features 1306A and 1306B may include nano twinned copper grain structure, which can aid in merging the conductive features during anneal. There is substantially no gap between the non-conductive bonding layers 1308A and 1308B at or near the bonded conductive features 1306A and 1306B. In some embodiments, a barrier layer may be provided under and/or laterally surrounding the conductive features 1306A and 1306B (e.g., which may include copper). In other embodiments, however, there may be no barrier layer under the conductive features 1306A and 1306B.

### Additional Examples of Memory-centric AI Accelerator Architecture

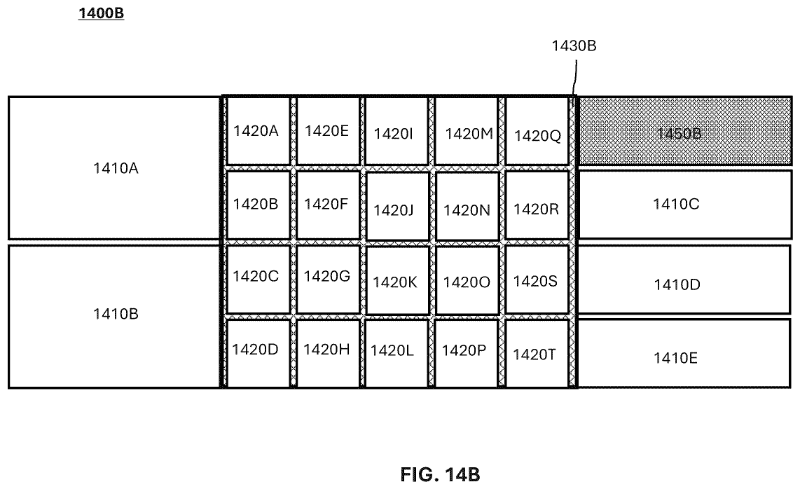

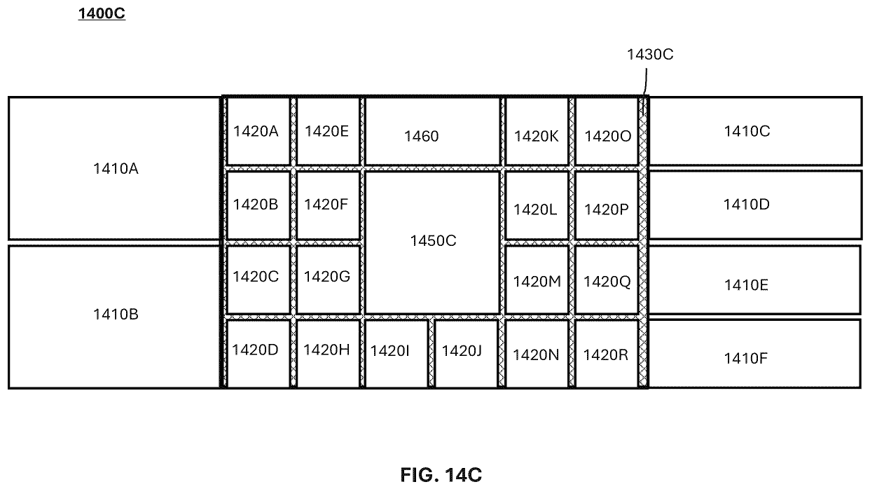

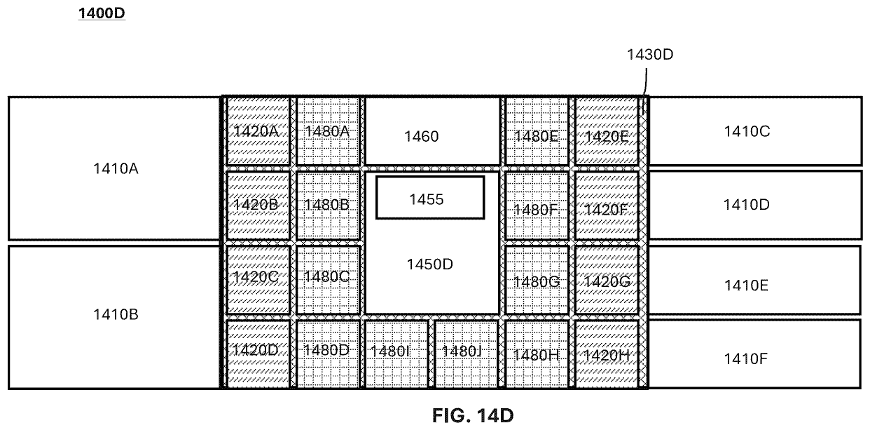

FIGS. 14A-14D illustrate additional examples of memory-centric AI accelerator architectures, according to embodiments disclosed herein. In various embodiments, the memory blocks are disposed centrally and surrounded by the processing blocks, which are closer to the periphery or edges of the arrangements for efficient heat transfer. In addition, the memory blocks are adjacent to each other and communicatively coupled through a NoC, which can be integrated as part of a logic base die.

In addition to the memory-centric AI accelerator architectures described above with respect to FIGS. 5A-5D, FIGS. 14A-14D illustrate additional embodiments of the memory-centric AI accelerator architectures. The AI accelerator architectures illustrated in FIGS. 14A-14D include aspects that can be the same or similar to those described with respect to FIGS. 5A-5D, and the similar features may not be repeated herein for brevity. For example, processing blocks and memory blocks, as will be described in FIGS. 14A-14D can correspond to the processing blocks and memory blocks illustrated in FIGS. 5A-5D. In addition, the numbers of processing blocks and memory blocks illustrated in FIGS. 14A-14D is merely provided as examples, and the present disclosure does not limit the number of processing blocks and memory blocks.

FIG. 14A illustrates an example arrangement of a memory-centric AI accelerator architecture 1400A, including multiple processing blocks 1410A-1410F, multiple memory blocks 1420A-1420T, a logic base die 1430A, and a memory management block 1450A. In some examples, the logic base die 1430A can include an NoC (not shown in FIG. 14B) (for example, integrated as part of a logic base die such as those described above with respect to FIGS. 1A and 1B). Each of the memory blocks 1420A-1420T is laterally adjacent to and contiguous with at least another one of the memory blocks 1420A-1420T. By omitting an intervening functional block or die, faster data transfer therebetween the memory blocks 1420A-1420T can be achieved. In some examples, the memory management block 1450A can include one or more memory controllers. In other examples, the memory management block 1450A can include the cache coherence circuitry and the MBIST component circuitry. In some embodiments, the memory management block 1450A can be fabricated as a single die, for example, at the same or less advanced node than the processing blocks 1410A-1410F.

In some examples, the memory blocks 1420A-1420T, and the memory management block 1450A are vertically stacked over and connected to the logic base die 1430A (e.g., connected to the NoC of the logic base die 1430A), for example, vertically directly stacked on the logic base die 1430A. In some examples, the memory management block 1450A and the logic base die 1430A are bonded, for example, through a suitable bonding technique, for example, using hybrid bonding techniques illustrated in FIGS. 13A and 13B. In the illustrated embodiment, the memory management block 1450A is centrally positioned within the logic base die 1430A and surrounded by the memory blocks 1420A-1420T. This configuration can enable the memory blocks 1420A-1420T and the memory management block 1450A to communicate through interconnections facilitated by the NoC included in the logic base die 1430A. For example, the NoC can be integrated as part of a logic base die 1430A such as those described above with respect to FIGS. 1A and 1B.

In certain embodiments, the processing blocks 1410A-1410F are positioned laterally around the logic base die 1430A, surrounding the memory blocks 1420A-1420T. In various embodiments, the processing blocks 1410A-1410F are closer to the periphery or edges of the illustrated arrangement and each can have one or more edges that are not adjacent to another die or block. Such arrangement can facilitate relatively unobstructed heat transfer from the processing blocks 1410A-1410F. These processing blocks correspond to the processing block 120 shown in FIGS. 1A-4, as well as the processing blocks 120AA-120FF depicted in FIG. 5A. Similarly, each memory block of the memory blocks 1420A-1420T can correspond to the memory block 110 described in FIG. 1A, which includes stacked memory with or without a memory base die and also to the memory blocks 120AA-120FF, as illustrated in FIG. 5A. The NoC 1430A can function as the communication backbone, facilitating signal routing between the processing blocks 1410A-1410F, the memory blocks 1420A-1420T, and the memory management block 1450A. In some embodiments, the L3 and/or the LLC cache memory can also be integrated with the NoC 1430A and communicatively coupled between the memory blocks 1420A-1420T and the processing blocks 1410A-1410F. In these embodiments, the NoC included in the logic base die 1430A can also provide various data communication standards, such as USR/UCIe interfaces for die interconnection (e.g., between processing blocks 1410A-1410F and the memory blocks 1420A-1420T), accelerator fabric links for data communication, as well as PCIe interfaces.

In the illustrated embodiment, the memory management block 1450A can be implemented as a chiplet disposed above the logic base die 1430A. However, embodiments are not so limited, and in other embodiments, the memory management block 1450A can be implemented as part of the logic base die 1430A.

In other embodiments, the L3 and/or the LLC cache memory can also be integrated with the memory management block 1450A and communicatively coupled between the memory blocks 1420A-1420T and the processing blocks 1410A-1410F via the NoC.

FIG. 14B illustrates an example arrangement of a memory-centric AI accelerator architecture 1400B, including multiple processing blocks 1410A-1410E, multiple memory blocks 1420A-1420T, a logic base die 1430B, and a memory management block 1450B. In some examples, the logic base die 1430B can include an NoC (not shown in FIG. 14B) (for example, integrated as part of a logic base die such as those described above with respect to FIGS. 1A and 1B). Aspects of the memory-centric AI accelerator architecture 1400B that are similar to those of the memory-centric AI accelerator architecture 1400A described above may not be repeated herein for brevity. Unlike the memory-centric AI accelerator architecture 1400A, the memory management block 1450B is disposed at an edge or a corner of the AI accelerator architecture 1400B. In some examples, the memory management block 1450B can include one or more memory controllers. In other examples, the memory management block 1450B can include the cache coherence circuitry and the MBIST component circuitry. In some embodiments, the memory management block 1450B can be fabricated as a single die.

In certain examples, the memory blocks 1420A-1420T are centrally integrated within the memory-centric AI accelerator architecture 1400B, with the memory management block 1450B and processing blocks 1410A-1410E arranged around or surrounding the memory blocks 1420A-1420T. The memory blocks 1420A-1420T are vertically bonded to the logic base die 1430B using a suitable bonding technique, such as a hybrid bonding technique (e.g., illustrated in FIGS. 13A and 13B). The memory management block 1450B can communicate with the NoC through die-to-die connection. Similarly, the processing blocks 1410A-1410E are also connected to the NoC using the die-to-die connection, enabling seamless communication between the memory management block 1450B, the processing blocks 1410A-1410E, and the NoC.

In some embodiments, the L3 and/or the LLC cache memory can also be integrated with the logic base die 1430B and communicatively coupled between the memory blocks 1420A-1420T and the processing blocks 1410A-1410E. In these embodiments, The NoC can be implemented in a logic base die (e.g., having the L3 and LLC cache memories), such as logic base dies 130A and 130B, illustrated in FIGS. 1A and 1B. In some examples, the NoC can also provide various data communication standards, such as USR/UCIe interfaces for die interconnection (e.g., between processing blocks 1410A-1410E and the memory blocks 1420A-1420T), accelerator fabric links for data communication, as well as PCIe interfaces. In other embodiments, the L3 and/or the LLC cache memory can also be integrated with the memory management block 1450B and communicatively coupled between the memory blocks 1420A-1420T and the processing blocks 1410A-1410E via the NoC 1430B.

FIG. 14C illustrates an example arrangement of a memory-centric AI accelerator architecture 1400C, including multiple processing blocks 1410A-1410F, multiple memory blocks 1420A-1420R, a logic base die 1430C, an interface block 1460, and a memory management block 1450C. In some examples, the logic base die 1430C can include an NoC (not shown in FIG. 14C) (for example, integrated as part of a logic base die such as those described above with respect to FIGS. 1A and 1B). Aspects of the memory-centric AI accelerator architecture 1400C that are similar to those of the memory-centric AI accelerator architectures 1400A and 1400B described above may not be repeated herein for brevity. Unlike the memory-centric AI accelerator architectures 1400A and 1400B, the AI accelerator architecture 1400C. includes an interface block 1460 disposed at an edge thereof. In some examples, the memory management block 1450C can be the same or similar to the memory management block 1450A and 1450B, illustrated in FIGS. 14A and 14B. The interface block 1460 can provide an optical interconnect between the memory management block 1450C (e.g., memory controller) and the memory blocks 1420A-1420R. In some cases, the interface block 1460 can include a SerDes (e.g., serialization/deserialization) interface. In these cases, the SerDes can serve as a high-speed communication interface between the memory management block 1450C (e.g., memory controller) and external components.

In some examples, the memory blocks 1420A-1420R, the interface block 1460, and the memory management block 1450C are vertically integrated with the logic base die 1430C, using a bonding technique such as hybrid bonding, as shown in FIGS. 13A and 13B. The memory management block 1450C is centrally positioned within the logic base die 1430C, directly adjoining the interface block 1460. Surrounding these central components are the memory blocks 1420A-1420R, as illustrated in FIG. 14C. In some examples, the NoC included in the logic base die 1430C establishes communication pathways between the memory blocks 1420A-1420R, the interface block 1460, and the memory management block 1450C. For instance, the memory management block 1450C can access individual memory blocks by interfacing with the memory blocks through the connections facilitated by the NoC and the interface block 1460 (e.g., via SerDes connections).

In some embodiments, the L3 and/or the LLC cache memory can also be integrated with the NoC included in the logic based die 1430C and communicatively coupled between the memory blocks 1420A-1420R, the processing blocks 1410A-1410F, and the interface block 1460. In some examples, the NoC can also provide various data communication standards, such as USR/UCIe interfaces for die interconnection (e.g., between processing blocks 1410A-1410F and the memory blocks 1420A-1420R), accelerator fabric links for data communication, as well as PCIe interfaces.

In other embodiments, the L3 and/or the LLC cache memory can also be integrated with the memory management block 1450C and communicatively coupled between the memory blocks 1420A-1420T and the processing blocks 1410A-1410F via the NoC 1430C and the interface block 1460.

FIG. 14D illustrates an example arrangement of a memory-centric AI accelerator architecture 1400D. The architecture includes multiple processing blocks 1410A-1410F, a first group of memory blocks 1420A-1420H, a second group of memory blocks 1480A-1480J, a logic base die 1430D, an interface block 1460, and a memory management block 1450D. In some examples, the logic base die 1430D can include an NoC (not shown in FIG. 14D) (for example, integrated as part of a logic base die such as those described above with respect to FIGS. 1A and 1B). Aspects of the memory-centric AI accelerator architecture 1400D that are similar to those of the memory-centric AI accelerator architectures 1400A, 1400B, 1400C described above may not be repeated herein for brevity. Unlike the memory-centric AI accelerator architectures 1400A, 1400B 1400C, the AI accelerator architecture 1400D. includes different types of memory blocks among the memory blocks. The memory management block 1450D can be identical or similar to the memory management blocks 1450A, 1450B, and 1450C described in FIGS. 14A-14C.

In this embodiment, the interface block 1460 provides a high bandwidth communication interface between the memory management block 1450D (e.g., acting as a memory controller) and external components. For example, the interface block 1460 can include optical I/O for photonic communication with external components. The memory blocks include the first group of memory blocks 1420A-1420H and the second group of memory blocks 1480A-1480J that have different characteristics based on their proximity to the processing blocks 1410A-1410F. In the illustrated embodiment, the first group of memory blocks 1420A-1420H are closer to the processing blocks 1410A-1410F relative to the second group of memory blocks 1480A-1480J.

It will be appreciated that, generally, performance of a memory device can be traded off with bit density. That is, memory devices having relatively high bandwidth can have relatively low bit density, for example, by placing memory blocks that are configured for relatively higher performance and lower bit density closer to the processing blocks and placing memory blocks that are configured for relatively higher bit density and lower performance farther away from the processing blocks, the overall performance of the memory blocks can be enhanced. Each memory block in the first group 1420A-1420H is characterized by higher bandwidth capabilities, for example, enabling these memory blocks optimal for frequently accessed data. In contrast, each memory block in the second group 1480A-1480J is designed for higher storage capacity at the expense of reduced bandwidth. The memory blocks in the first group 1420A-1420H may include any of the stacked memory technologies 602, 604, or 606, as depicted in FIG. 6. In some cases, each memory block of the second group of memory blocks 1480A-1480J can include a denser memory block (than the memory block of the first group of memory blocks), such as a three-dimensional DRAM, stacked DRAM, and or NAND flash memory (e.g., high density memory used in non-volatile storage medium), high density DRAM (e.g., DDR5, LPDDR5, GDDR6, and the like), NV-RAM (e.g., non-volatile random access memory), and the like.

The first group of memory blocks 1420A-1420H, the second group of memory blocks 1480A-1480J, the interface block 1460, and the memory management block 1450D are vertically connected to the logic base die 1430D (e.g., having the NoC) using a bonding techniques, such as hybrid bonding, as illustrated in FIGS. 13A and 13B. The memory management block 1450D is centrally positioned within the logic base die 1430D, with the interface block 1460 directly adjacent to memory management block 1450D. The second group of memory blocks 1480A-1480J can be arranged to surround the memory management block 1450D and the interface block 1460, while the first group of memory blocks 1420A-1420H can be arranged to surround the second group of memory blocks 1480A-1480J. In some cases, the processing blocks 1410A-1410F can be disposed on the outermost, such that the processing blocks 1410A-1410F can surround the first group of memory blocks 1420A-1420H.

This hierarchical arrangement positions the first group of memory blocks 1420A-1420H closer to the processing blocks 1410A-1410F, facilitating faster data access due to their higher bandwidth. Conversely, the second group of memory blocks 1480A-1480J, located nearer the memory management block 1450D, is optimized for high-capacity data storage. This configuration ensures efficient data access and storage by matching the memory characteristics with the application (e.g., application of the AI accelerator) requirements.

The memory management block 1450D may include an AI module 1455, implemented using a processor such as a CPU, NPU, TPU, or GPU. This AI module can be trained to analyze data usage patterns and optimize storage allocation. For example, frequently accessed data is stored in the high-bandwidth memory blocks of the first group 1420A-1420H, while less frequently accessed data is allocated to the high-capacity memory blocks of the second group 1480A-1480J. By dynamically managing data placement based on access patterns, the AI module 1455 enhances the overall efficiency and performance of the memory-centric AI accelerator architecture

In some embodiments, memory management block 1450D is responsible for orchestrating the movement of data from higher-density, lower-speed memory blocks to high-transfer-rate memory blocks positioned nearer to or adjacent to the processing blocks. This architecture effectively enables the overall memory hierarchy to achieve the enhanced functionality of higher-density memory with faster performance, optimizing data access and throughput. Additionally, in some embodiments, the memory management block is tasked with controlling the allocation and retention of data within the SRAM (L3 cache) located on the logic base die, ensuring efficient utilization of cache resources to reduce latency and improve computational performance.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled,” as generally used herein, refers to two or more elements that may be either directly connected, or connected by way of one or more intermediate elements. Likewise, the word “connected,” as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Moreover, as used herein, when a first element is described as being “on” or “over” a second element, the first element may be directly on or over the second element, such that the first and second elements directly contact, or the first element may be indirectly on or over the second element such that one or more elements intervene between the first and second elements. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements, and/or states are in any way required for one or more embodiments.

While certain embodiments have been described, these embodiments have been presented by way of example only and are not intended to limit the scope of the disclosure. Indeed, the novel apparatus, methods, and systems described herein may be embodied in a variety of other forms; furthermore, various omissions, substitutions, and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

The number of semiconductor components illustrated herein is merely provided as examples for the purpose of description, and the present disclosure is not limited to the number of components illustrated herein.

1. An artificial intelligence (AI) accelerator comprising:
a processing block and a memory block disposed laterally side-by-side to each other and over a common substrate;
the processing block comprising a computing die, the computing die comprising a plurality of parallel processing cores for processing artificial intelligence algorithms;
the memory block heterogeneously integrated with the processing block through electrical connections formed in the common substrate, the memory block comprising a memory stack comprising one or more vertically stacked memory die layers; and
a logic base die vertically interposed between the common substrate and the memory block, wherein the logic base die comprises one or more data communication interfaces between the memory block and the processing block, and wherein the data communication interfaces include a network on chip (NoC) configured to electrically connect the memory block with each of the parallel processing cores.

2. The AI accelerator of claim 1, wherein the common substrate is a semiconductor interposer comprising electrical connections therein for electrically connecting the memory block and the processing block.

3. The AI accelerator of claim 1, wherein the NoC comprises links and routers configured to route signal between the memory block and each processing core included in the processing block, wherein the links and routers are monolithically integrated at different process architecture technology node relative to a process architecture technology node of each processing core.

4. The AI accelerator of claim 1, wherein the AI accelerator comprises multiple levels of cache memory, and wherein the logic base die comprises a highest level of the multiple levels of cache memory.

5. The AI accelerator of claim 4, and wherein the logic base die comprises a level three (L3) cache memory comprising a monolithically integrated static random access memory (SRAM).

6. The AI accelerator of claim 4, wherein the computing die comprises a monolithically integrated level one (L1) cache memory and a level two (L2) cache memory each comprising a monolithically integrated SRAM.

7. The AI accelerator of claim 1, wherein the computing die is electrically connected to the electrical connections formed in the common substrate without an intervening die.

8. The AI accelerator of claim 1, wherein the memory stack and the processing die are electrically connected to each other by through silicon vias (TSVs) formed through one or more of the memory die layer and the logic base die.

9. The AI accelerator of claim 1, wherein one or both of the computing die and the logic base die are directly bonded to the substrate by hybrid bonding.

10. The AI accelerator of claim 1, further comprising a memory base die positioned vertically between the memory stack and the logic base die, the memory base die comprising a memory peripheral circuitry configured for controlling operations of the one or more of the vertically stacked memory die layers.

11. The AI accelerator of claim 10, further comprising multiple levels of cache memory, and wherein the memory base die comprises one of the multiple levels of cache memory.

12. The AI accelerator of claim 10, wherein the memory peripheral circuitry comprises a memory controller to control the operations of one or more memories in the stacked memories and a built-in self-test unit configured to monitor operational defects in the one or more memories.

13. The AI accelerator of claim 1, wherein each memory of one or more memories in the stacked memories comprises a dynamic random access memory (DRAM).

14. The AI accelerator of claim 13, wherein the DRAM comprises a processing in memory (PIM), the PIM comprising circuitry configured to process data retrieved from a corresponding DRAM.

15. The AI accelerator of claim 1, wherein the one or more data communication interfaces further comprise at least one of an accelerator fabric link and a PCI express.

16. The AI accelerator of claim 15, wherein the accelerator fabric link and the PCI express are configured to provide data communication between the memory block and one or more external AI accelerators.

17. The AI accelerator of claim 1, wherein the memory stack comprises 4, 8, or 12 stacked vertically stacked memory die layers.

18. The AI accelerator of claim 1, wherein the logic base die further comprises one or more static random access memories (SRAMs).

19. The AI accelerator of claim 1, wherein the processing cores include graphical processing unit cores.

20. The AI accelerator of claim 19, wherein the processing cores include a combination of graphical processing unit cores and neural processing unit cores.

21.-121. (canceled)
